(19) United States
(12) Patent Application Publication
(10) Pub. No.: US 2014/0188543 A1
(43) Pub. Date: Jul. 3, 2014

(54) Optimized Bioresources and Bioprocessing

(71) Applicant: Sweetwater Energy, Inc., Rochester, NY (US)

(72) Inventors: Nina L. Pearlmutter, Kennebunkport, ME (US); Arunas Chesonis, Rochester, NY (US); Keith M. Wilson, Pittsford, NY (US)

(21) Appl. No.: 14/140,880

(22) Filed: Dec. 26, 2013

Related U.S. Application Data
(60) Provisional application No. 61/746,753, filed on Dec. 28, 2012.

(51) Int. Cl. G06Q 10/06

(52) U.S. Cl. CPC G06Q 10/06315
USPC 705/7.25

(57) ABSTRACT

Provided is a system of hardware, software, and business methods for developing a management plan to optimize biomass resources for biochemical production. In particular, the method uses programming and resource data and information input from one or more resource sites to allow a manager to determine optimal allocations of biomass resources for pretreatment industry plants.

### CROSS-REFERENCE

This application claims the benefit of U.S. Provisional Application No. 61/746,753, filed Dec. 28, 2012, which application is incorporated herein by reference in its entirety.

### BACKGROUND OF THE INVENTION

Biomass is an abundant potential source of fuels and specialty chemicals. Almost any kind of biomass can be used to extract carbohydrates, proteins, fats, and other valuable compounds, but, in particular, the carbohydrate polymers of biomass derived from plants, algae or microorganisms are sought after to produce such biochemicals. If a biobased operation is to be successful, supplies of carbohydrate-rich feedstocks must be carefully coordinated and controlled in the production of a product. There are many variables that affect the cost of feedstocks and, ultimately, the cost of biofuels and biochemicals derived from them. Climate, location, growing season, harvest conditions, transport costs, dry weights, and preservation of these resources are just a few. The composition of a biomass can be critical as pretreatment methods to extract sugars vary due to the amount and binding between of starch, lignin, cellulose and hemicellulose in a particular feedstock resource and any additional components that affect the extraction and quality of the product.

One way to organize the supply of raw agricultural products is to form one or more REITs or similar types of agronomic monitoring and control. But formation isn't enough. The operation of such an organization must take into account the operation of the pretreatment and biochemical plants that utilize that feedstock. To compete with products made from fossil fuels, feedstock prices must be kept low and predictable. Given the numerous varied bioresource sites and the many types of pretreatment plants that produce sugars, crop strategies must take into account not only risk management regarding growing factors, but evaluation of market information.

With these variables in mind, there is clearly a need for a system of organization and controlled feedback that plans for and predicts not only the availability of a type of biomass, but feedback mechanisms from industrial consumers that assist in the adequate and economical supply of desirable feedstock resources.

### SUMMARY OF THE INVENTION

In one aspect, disclosed herein are systems for optimized biomass resource utilization in the production of sugars, the systems comprising: (a) two or more biomass resource sites; (b) a site data collecting and transmitting device at each of the two or more biomass resource sites to transmit biomass resource data to a resource manager system; (c) one or more pretreatment plants; (d) a plant data collecting and transmitting device at each of the one or more pretreatment plants to transmit pretreatment plant data to the resource manager system; (e) the resource manager system for optimizing biomass resource utilization comprising: (i) one or more processors, and (ii) memory, including instructions executable by the one or more processors to cause the computer system to at least: (1) obtain one or more evaluation rules based at least in part on historical data, (2) determine one or more resource optimization predictions based at least in part upon the one or more evaluation rules, the biomass resource data, and the pretreatment plant data, and (3) determine a type of biomass resource to produce and a cost of producing the biomass resource based at least in part upon the one or more resource optimization predictions.

In some embodiments, the resource manager system further comprises instructions that transmits a price for the biomass resource to at least one pretreatment plant.

In some embodiments, the one or more resource optimization predictions comprise a cost for a measured unit of the biomass resource, the cost of producing sugars from the biomass resource, or a combination thereof.

In some embodiments, the biomass resource is a future biomass resource.

In some embodiments, obtaining the one or more evaluation rules includes analyzing the historical data using a machine learning technique. In some embodiments, the one or more evaluation rules are an agronomic model.

In some embodiments, the two or more biomass resource sites comprise farmland, timberland, municipal waste sites, aquatic farms, lumber mills, or a combination thereof. In some embodiments, the two or more biomass resource sites comprise the aquatic farm that is an oceanic farm.

In some embodiments, the two or more biomass resource sites are in common ownership or in an association or trust.

In some embodiments, the biomass resource comprises cellulose, hemicellulose, or lignocellulose.

In some embodiments, at least one pretreatment plant is portable.

In some embodiments, at least one pretreatment plant is located at least one biomass resource site.

In some embodiments, the site data collecting and transmitting device collects data from one or more environmental monitoring devices, one or more user input devices, or a combination thereof. In some embodiments, the one or more environmental monitoring devices that comprise a thermometer, a humidity sensor, a light sensor, a rain gauge, a wind sensor, a clock, a location determining receiver, or a combination thereof. Some embodiments comprise the one or more user input devices for automatically or manually entering environmental data, crop data, harvest data, or a combination thereof.

In some embodiments, the biomass resource data comprises environmental data, crop data, harvest data, or a combination thereof. In some embodiments, the biomass resource data comprises the environmental data that comprises temperature data, humidity data, light data, rain data, wind data, time, soil nutrient data, location data, or a combination thereof. In some embodiments, the biomass resource data comprises the crop data that comprises growth data, insect data, parasite data, disease data, crop damage data, or a combination thereof. In some embodiments, the biomass resource data comprises the harvest data that comprises what was harvested, how much was harvested, the moisture content of the harvested material, the saccharide content (e.g., ratio of starch, lignin, cellulose, and hemicellulose) of the harvested material, or a combination thereof.

In some embodiments, the plant data collecting and transmitting device collects data from one or more equipment monitoring devices, one or more user input devices, or a combination thereof. Some embodiments comprise the one or more equipment monitoring devices that comprise a thermometer, a pressure gauge, a pH meter, a clock, or a combination thereof. Some embodiments comprise the one or more user input devices for automatically or manually entering pretreatment protocols, particle size data, saccharide yields, inhibitor or chemical levels, biomass resource needs, or a combination thereof.

In some embodiments, the pretreatment plant data comprises biomass resource needs, pretreatment parameters, saccharide yields, saccharide purity levels, or a combination thereof. In some embodiments, the pretreatment plant data comprises the biomass resource needs that comprise a type of biomass resource, an amount of biomass resource, or a combination thereof. In some embodiments, the pretreatment plant data comprises the pretreatment parameters that comprise a pretreatment protocol; a process temperature, pressure, pH, time, particle size; or a combination thereof. In some embodiments, the pretreatment plant data comprises the saccharide purity levels that comprise saccharide concentration, inhibitor or chemical concentration, or a combination thereof.

In some embodiments, the resource manager system further comprises instructions that transmits a biomass resource site prescription to at least one biomass resource site. In some embodiments, the biomass resource site prescription comprises labor requirements, equipment requirements, material requirements, or a combination thereof. In some embodiments, the biomass resource site prescription comprises instructions for planting, watering, fertilizing, pesticide treating, harvesting, post-harvest processing, shipping, or a combination thereof. In some embodiments, the biomass resource site prescription comprises instructions for planting that comprise when to plant, where to plant, what to plant, an amount to plant, or a combination thereof. In some embodiments, the biomass resource site prescription comprises instructions for watering that comprise when to water, where to water, how much to water, or a combination thereof. In some embodiments, the biomass resource site prescription comprises instructions for fertilizing that comprise when to fertilize, where to fertilize, what fertilizer to use, how much fertilizer to use, or a combination thereof. In some embodiments, the biomass resource site prescription comprises instructions for pesticide treating that comprise when to treat, where to treat, what pesticide to use, how much pesticide to use, or a combination thereof. In some embodiments, the biomass resource site prescription comprises instructions for harvesting that comprise when to harvest, where to harvest, what to harvest, how much to harvest, or a combination thereof. In some embodiments, the biomass resource site prescription comprises instructions for post-harvest processing that comprise hydrating the harvested biomass, drying the harvested biomass, storing the harvested biomass, or a combination thereof. In some embodiments, the biomass resource site prescription comprises instructions for shipping that comprise what to ship, where to ship, an amount to ship, or a combination thereof.

In some embodiments, the resource manager system further comprises instructions that transmits a pretreatment plant prescription to at least one pretreatment plant. In some embodiments, the pretreatment plant prescription comprises instructions for extraction of sugars from the biomass resource, refinement of sugars, or a combination thereof.

Some embodiments further comprise one or more biochemical plants.

Some embodiments further comprise a biochemical plant data collecting and transmitting device at each of the one or more biochemical plants to transmit biochemical plant data to the resource manager system. In some embodiments, the biochemical plant data collecting and transmitting device collects data from one or more equipment monitoring devices, one or more user input devices, or a combination thereof. Some embodiments comprise the one or more equipment monitoring devices that comprise a thermometer, a pressure gauge, a pH meter, a clock, or a combination thereof. Some embodiments comprise the one or more user input devices for automatically or manually biochemical processing protocols, sugar resource needs, sugar consumption during processing, bioproduct yield, or a combination thereof. Some embodiments comprise the sugar resource needs that comprise a type, purity level, or amount of a sugar resource needed.

In some embodiments, the biochemical plant data comprises biochemical processing protocols, biochemical process parameters, sugar resource needs, sugar consumption during processing, bioproduct yield, or a combination thereof. In some embodiments, the biochemical plant data comprises the biochemical process parameters that comprise temperature, pressure, pH, time, or a combination thereof. In some embodiments, the biochemical plant data comprises the sugar resource needs that comprise a type of sugar, an amount of sugar resource, a purity level, or a combination thereof. In some embodiments, the biochemical plant data comprises the biochemical processing parameters that comprise a temperature, pressure, pH, time, or a combination thereof.

In some embodiments, the resource manager system further comprises instructions that transmits a biochemical plant prescription to at least one biochemical plant. In some embodiments, the pretreatment plant prescription comprises a price for a sugar resource, instructions for the production of a biochemical from the sugar resource, or a combination thereof.

In another aspect, disclosed are computer-implemented methods for optimizing biomass resource utilization, the methods under the control of one or more computer systems configured with executable instructions and comprising: (a) obtaining biomass resource data from two or more biomass resource sites; (b) obtaining pretreatment plant data from one or more pretreatment plants; (c) obtaining one or more evaluation rules based at least in part on historical data; (d) determining one or more resource optimization predictions based at least in part upon the one or more evaluation rules, the biomass resource data, and the pretreatment plant data, and (e) determining a type of biomass resource to produce and a cost of producing the biomass resource based at least in part upon the one or more resource optimization predictions.

Some embodiments further comprise measuring at least some of the biomass resource data.

Some embodiments further comprise transmitting a price for the biomass resource to at least one pretreatment plant.

In some embodiments, the one or more resource optimization predictions comprise a cost for a measured unit of the biomass resource, the cost of producing sugars from the biomass resource, or a combination thereof.

In some embodiments, the biomass resource is a future biomass resource.

In some embodiments, obtaining the one or more evaluation rules includes analyzing the historical data using a machine learning technique. In some embodiments, the one or more evaluation rules are an agronomic model.

In some embodiments, the two or more biomass resource sites comprise farmland, timberland, municipal waste sites, aquatic farms, lumber mills, or a combination thereof. In some embodiments, the two or more biomass resource sites comprise the aquatic farm that is an oceanic farm.

In some embodiments, the two or more biomass resource sites are in common ownership or in an association or trust.

In some embodiments, the biomass resource comprises cellulose, hemicellulose, or lignocellulose.

In some embodiments, at least one pretreatment plant is portable. In some embodiments, at least one pretreatment plant is located at least one biomass resource site.

In some embodiments, the biomass resource data is obtained from one or more site data collecting and transmitting devices located at each of the two or more biomass resource sites. In some embodiments, the site data collecting and transmitting device collects data from one or more environmental monitoring devices, one or more user input devices, or a combination thereof. Some embodiments comprise the one or more environmental monitoring devices that comprise a thermometer, a humidity sensor, a light sensor, a rain gauge, a wind sensor, a clock, a location determining receiver, or a combination thereof. Some embodiments comprise the one or more user input devices for automatically or manually entering environmental data, crop data, harvest data, or a combination thereof.

In some embodiments, the biomass resource data comprises environmental data, crop data, harvest data, or a combination thereof. In some embodiments, the biomass resource data comprises the environmental data that comprises temperature data, humidity data, light data, rain data, wind data, time, soil nutrient data, location data, or a combination thereof. In some embodiments, the biomass resource data comprises the crop data that comprises growth data, insect data, parasite data, disease data, crop damage data, or a combination thereof. In some embodiments, the biomass resource data comprises the harvest data that comprises what was harvested, how much was harvested, the moisture content of the harvested material, the saccharide content (e.g., ratio of starch, lignin, cellulose, and hemicellulose) of the harvested material, or a combination thereof.

In some embodiments, the pretreatment plant data is obtained from one or more plant data collecting and transmitting device located at each of the one or more pretreatment plants. In some embodiments, the plant data collecting and transmitting device collects data from one or more equipment monitoring devices, one or more user input devices, or a combination thereof. Some embodiments comprise the one or more equipment monitoring devices that comprise a thermometer, a pressure gauge, a pH meter, a clock, or a combination thereof. Some embodiments comprise the one or more user input devices for automatically or manually entering pretreatment protocols, particle size data, saccharide yields, inhibitor or chemical levels, biomass resource needs, or a combination thereof.

In some embodiments, the pretreatment plant data comprises biomass resource needs, pretreatment parameters, saccharide yields, saccharide purity levels, or a combination thereof. In some embodiments, the pretreatment plant data comprises the biomass resource needs that comprises a type of biomass resource, an amount of biomass resource, or a combination thereof. In some embodiments, the pretreatment plant data comprises the pretreatment parameters that comprise a pretreatment protocol; a process temperature, pressure, pH, time, particle size; or a combination thereof. In some embodiments, the pretreatment plant data comprises the saccharide purity levels that comprise saccharide concentration, inhibitor or chemical concentration, or a combination thereof.

Some embodiments further comprise transmitting a biomass resource site prescription to at least one biomass resource site. Some embodiments further comprise producing the biomass resource according to the biomass resource site prescription. In some embodiments, the biomass resource site prescription comprises labor requirements, equipment requirements, material requirements, or a combination thereof. In some embodiments, the biomass resource site prescription comprises instructions for planting, watering, fertilizing, pesticide treating, harvesting, post-harvest processing, shipping, or a combination thereof. In some embodiments, the biomass resource site prescription comprises instructions for planting that comprise when to plant, where to plant, what to plant, an amount to plant, or a combination thereof. In some embodiments, the biomass resource site prescription comprises instructions for watering that comprise when to water, where to water, how much to water, or a combination thereof. In some embodiments, the biomass resource site prescription comprises instructions for fertilizing that comprise when to fertilize, where to fertilize, what fertilizer to use, how much fertilizer to use, or a combination thereof. In some embodiments, the biomass resource site prescription comprises instructions for pesticide treating that comprise when to treat, where to treat, what pesticide to use, how much pesticide to use, or a combination thereof. In some embodiments, the biomass resource site prescription comprises instructions for harvesting that comprise when to harvest, where to harvest, what to harvest, how much to harvest, or a combination thereof. In some embodiments, the biomass resource site prescription comprises instructions for post-harvest processing that comprise hydrating the harvested biomass, drying the harvested biomass, storing the harvested biomass, or a combination thereof. In some embodiments, the biomass resource site prescription comprises instructions for shipping that comprise what to ship, where to ship, an amount to ship, or a combination thereof.

Some embodiments further comprise transmitting a pretreatment plant prescription to at least one pretreatment plant. Some embodiments further comprise producing sugars according to the pretreatment plant prescription. In some embodiments, the pretreatment plant prescription comprises instructions for extraction of sugars from the biomass resource, refinement of sugars, or a combination thereof.

Some embodiments further comprise obtaining biochemical plant data from one or more biochemical plants.

In some embodiments, the biochemical plant data is obtained from one or more biochemical plant data collecting and transmitting devices at each of the one or more biochemical plants. In some embodiments, the biochemical plant data collecting and transmitting device collects data from one or more equipment monitoring devices, one or more user input devices, or a combination thereof. Some embodiments comprise the one or more equipment monitoring devices that comprise a thermometer, a pressure gauge, a pH meter, a clock, or a combination thereof. Some embodiments comprise the one or more user input devices for automatically or manually biochemical processing protocols, sugar resource needs, sugar consumption during processing, bioproduct yield, or a combination thereof. Some embodiments comprise the sugar resource needs that comprise a type, purity level, or amount of a sugar resource needed.

In some embodiments, the biochemical plant data comprises biochemical processing protocols, biochemical process parameters, sugar resource needs, sugar consumption during processing, bioproduct yield, or a combination thereof. In some embodiments, the biochemical plant data comprises the biochemical process parameters that comprise temperature, pressure, pH, time, or a combination thereof. In some embodiments, the biochemical plant data comprises the sugar resource needs that comprise a type of sugar, an amount of sugar resource, a purity level, or a combination thereof. In some embodiments, the biochemical plant data comprises the biochemical processing parameters that comprise a temperature, pressure, pH, time, or a combination thereof.

Some embodiments further comprise transmitting a biochemical plant prescription to at least one biochemical plant. In some embodiments, the pretreatment plant prescription comprises a price for a sugar resource, instructions for the production of a biochemical from the sugar resource, or a combination thereof. Some embodiments further comprise producing a bioproduct according to the biochemical plant prescription.

In another aspect, disclosed herein are computer systems for optimizing biomass resource utilization, comprising: (a) one or more processors; and, (b) memory, including instructions executable by the one or more processors to cause the computer system to at least: (i) obtain biomass resource data from two or more biomass resource sites, (ii) obtain pretreatment plant data from one or more pretreatment plants, (iii) obtain one or more evaluation rules based at least in part on historical data, (iv) determine one or more resource optimization predictions based at least in part upon the one or more evaluation rules, the biomass resource data, and the pretreatment plant data, (v) determine a type of biomass resource to produce and a cost of producing the biomass resource based at least in part upon the one or more resource optimization predictions, and (vi) transmit a price for the biomass resource to at least one pretreatment plant.

In some embodiments, the one or more resource optimization predictions comprise a cost for a measured unit of the biomass resource, the cost of producing sugars from the biomass resource, or a combination thereof.

In some embodiments, the biomass resource is a future biomass resource.

In some embodiments, the one or more evaluation rules are obtained by analyzing the historical data using a machine learning technique. In some embodiments, the one or more evaluation rules are an agronomic model.

In some embodiments, the two or more biomass resource sites comprise farmland, timberland, municipal waste sites, aquatic farms, lumber mills, or a combination thereof. In some embodiments, the two or more biomass resource sites comprise the aquatic farm that is an oceanic farm.

In some embodiments, the two or more biomass resource sites are in common ownership or in an association or trust.

In some embodiments, the biomass resource comprises cellulose, hemicellulose, or lignocellulose.

In some embodiments, at least one pretreatment plant is portable. In some embodiments, at least one pretreatment plant is located at least one biomass resource site.

In some embodiments, the biomass resource data is obtained from one or more site data collecting and transmitting devices located at each of the two or more biomass resource sites. In some embodiments, the site data collecting and transmitting device collects data from one or more environmental monitoring devices, one or more user input devices, or a combination thereof. Some embodiments comprise the one or more environmental monitoring devices that comprise a thermometer, a humidity sensor, a light sensor, a rain gauge, a wind sensor, a clock, a location determining receiver, or a combination thereof. Some embodiments comprise the one or more user input devices for automatically or manually entering environmental data, crop data, harvest data, or a combination thereof.

In some embodiments, the biomass resource data comprises environmental data, crop data, harvest data, or a combination thereof. In some embodiments, the biomass resource data comprises the environmental data that comprises temperature data, humidity data, light data, rain data, wind data, time, soil nutrient data, location data, or a combination thereof. In some embodiments, the biomass resource data comprises the crop data that comprises growth data, insect data, parasite data, disease data, crop damage data, or a combination thereof. In some embodiments, the biomass resource data comprises the harvest data that comprises what was harvested, how much was harvested, the moisture content of the harvested material, the saccharide content (e.g., ratio of starch, lignin, cellulose, and hemicellulose) of the harvested material, or a combination thereof.

In some embodiments, the pretreatment plant data is obtained from one or more plant data collecting and transmitting device located at each of the one or more pretreatment plants. In some embodiments, the plant data collecting and transmitting device collects data from one or more equipment monitoring devices, one or more user input devices, or a combination thereof. Some embodiments comprise the one or more equipment monitoring devices that comprise a thermometer, a pressure gauge, a pH meter, a clock, or a combination thereof. Some embodiments comprise the one or more user input devices for automatically or manually entering pretreatment protocols, particle size data, saccharide yields, inhibitor or chemical levels, biomass resource needs, or a combination thereof.

In some embodiments, the pretreatment plant data comprises biomass resource needs, pretreatment parameters, saccharide yields, saccharide purity levels, or a combination thereof. In some embodiments, the pretreatment plant data comprises the biomass resource needs that comprise a type of biomass resource, an amount of biomass resource, or a combination thereof. In some embodiments, the pretreatment plant data comprises the pretreatment parameters that comprise a pretreatment protocol; a process temperature, pressure, pH, time, particle size; or a combination thereof. In some embodiments, the pretreatment plant data comprises the saccharide purity levels that comprise saccharide concentration, inhibitor or chemical concentration, or a combination thereof.

Some embodiments further comprise executable instructions to transmit a biomass resource site prescription to at least one biomass resource site. In some embodiments, the biomass resource site prescription comprises labor requirements, equipment requirements, material requirements, or a combination thereof. In some embodiments, the biomass resource site prescription comprises instructions for planting, watering, fertilizing, pesticide treating, harvesting, post-harvest processing, shipping, or a combination thereof. In some embodiments, the biomass resource site prescription comprises instructions for planting that comprise when to plant, where to plant, what to plant, an amount to plant, or a combination thereof. In some embodiments, the biomass resource site prescription comprises instructions for watering that comprise when to water, where to water, how much to water, or a combination thereof. In some embodiments, the biomass resource site prescription comprises instructions for fertilizing that comprise when to fertilize, where to fertilize, what fertilizer to use, how much fertilizer to use, or a combination thereof. In some embodiments, the biomass resource site prescription comprises instructions for pesticide treating that comprise when to treat, where to treat, what pesticide to use, how much pesticide to use, or a combination thereof. In some embodiments, the biomass resource site prescription comprises instructions for harvesting that comprise when to harvest, where to harvest, what to harvest, how much to harvest, or a combination thereof. In some embodiments, the biomass resource site prescription comprises instructions for post-harvest processing that comprise hydrating the harvested biomass, drying the harvested biomass, storing the harvested biomass, or a combination thereof. In some embodiments, the biomass resource site prescription comprises instructions for shipping that comprise what to ship, where to ship, an amount to ship, or a combination thereof.

Some embodiments further comprise executable instructions to transmit a pretreatment plant prescription to at least one pretreatment plant. In some embodiments, the pretreatment plant prescription comprises instructions for extraction of sugars from the biomass resource, refinement of sugars, or a combination thereof.

Some embodiments further comprise obtaining biochemical plant data from one or more biochemical plants. In some embodiments, the biochemical plant data is obtained from one or more biochemical plant data collecting and transmitting devices at each of the one or more biochemical plants. In some embodiments, the biochemical plant data collecting and transmitting device collects data from one or more equipment monitoring devices, one or more user input devices, or a combination thereof. Some embodiments comprise the one or more equipment monitoring devices that comprise a thermometer, a pressure gauge, a pH meter, a clock, or a combination thereof. Some embodiments comprise the one or more user input devices for automatically or manually entering biochemical processing protocols, sugar resource needs, sugar consumption during processing, bioproduct yield, or a combination thereof. Some embodiments comprise the sugar resource needs that comprise a type, purity level, or amount of a sugar resource needed.

In some embodiments, the biochemical plant data comprises biochemical processing protocols, biochemical process parameters, sugar resource needs, sugar consumption during processing, bioproduct yield, or a combination thereof. In some embodiments, the biochemical plant data comprises the biochemical process parameters that comprise temperature, pressure, pH, time, or a combination thereof. In some embodiments, the biochemical plant data comprises the sugar resource needs that comprise a type of sugar, an amount of sugar resource, a purity level, or a combination thereof. In some embodiments, the biochemical plant data comprises the biochemical processing parameters that comprise a temperature, pressure, pH, time, or a combination thereof.

Some embodiments further comprise transmitting a biochemical plant prescription to at least one biochemical plant. In some embodiments, the pretreatment plant prescription comprises a price for a sugar resource, instructions for the production of a biochemical from the sugar resource, or a combination thereof.

In another aspect, disclosed herein are methods, implemented through electronic and/or satellite communication and on a data processor, for optimizing the consumption of biomass resources, the methods comprising: (a) obtaining data input from two or more biomass resource sites, the two or more sites in common ownership or in an association or trust, wherein data input comprises: (i) measuring environmental data, (ii) measuring crop data, and (iii) transmitting (i) and (ii) to a system manager; and (b) processing the data to determine the cost of producing the biomass resource; (c) estimating a cost for a measured unit of the biomass resource; (d) obtaining data input from a pretreatment plant comprising: (i) the suitability of the feedstock for pretreatment; (ii) the yield and type of sugars extracted from the biomass resource; and (iii) the purity of the sugars derived from the biomass resource; (e) determining the cost of producing sugars from the biomass resource; (f) using (c) and (e) to determine the cost of future biomass resource; and (g) using (d) to determine the type of future biomass resource to produce.

In some embodiments, the pretreatment plant is located at one or more of the biomass resource sites. In some embodiments, the pretreatment plant data is located at a site not a biomass resource site. In some embodiments, the environmental data comprises measurements of at least field temperature and soil moisture. In some embodiments, the crop data comprises at least insect and/or disease measurements.

In another aspect, disclosed herein are systems for estimating a biomass requirement comprising: (a) obtaining data from one or more biomass resource site, wherein the data comprises: (i) environmental data, and (ii) crop data; (b) obtaining pretreatment plant data from one or more pretreatment plant wherein the pretreatment plant data comprises: (i) a type of biomass resource required, and (ii) an amount of biomass resource required; and (c) a computer including: (i) a data processor for processing and analyzing: (4) the data from one or more biomass resource site, (5) the data from one or more pretreatment plant; and (ii) a report generator to predict the type and amount of bioresource required for one or more pretreatment plant.

In some embodiments, the data is obtained by means of a collector and formatter and transceiver. In some embodiments, the collector collects environmental data and crop data.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features disclosed herein are set forth with particularity in the appended claims. A better understanding of the features and advantages will be obtained by reference to the following detailed description that sets forth illustrative embodiments, in which the principles of the disclosure are utilized, and the accompanying drawings of which:

FIG. 1 is an illustrative diagram indicating the operation of a REIT and communication with a pretreatment plant.

FIG. 2 is a flow diagram of a method for controlling and optimizing consumption of bioresources through data input and communication between a system manager and consuming entities of bioresources.

FIG. 3 is a diagram of a system for estimating and transmitting agricultural parameters.

FIG. 4 is an illustrative diagram of the optimization of bioresources between a system manager and consumers of bioresources.

FIG. 5 is an illustration of an example environment for implementing the present invention, in accordance with an embodiment.

FIG. 6 is an illustration of example components of a resource manager system, in accordance with an embodiment.

FIG. 7 is an illustration of example components of a computer device for implementing aspects of the present invention, in accordance with an embodiment.

FIG. 8 is an illustration of an example process for implementing the present invention, in accordance with an embodiment.

FIG. 9 is an illustration of an example process for determining a type of biomass resource to produce and the cost of producing the resource, in accordance with an embodiment.

### DETAILED DESCRIPTION OF THE INVENTION

As used in the specification and the appended claims, the singular forms “a,” “an” and “the” include plural referents unless the context clearly dictates otherwise. Thus, for example, reference to “a purified monomer” includes mixtures of two or more purified monomers. The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Whenever the phrase “for example,” “such as,” “including” and the like are used herein, the phrase “and without limitation” is understood to follow unless explicitly stated otherwise. Therefore, “for example ethanol production” means “for example and without limitation ethanol production.”

As used herein, “or” can be conjunctive or disjunctive.

In this specification and in the claims that follow, reference will be made to a number of terms which shall be defined to have the following meanings. Unless characterized otherwise, technical and scientific terms used herein have the same meaning as commonly understood by one of ordinary skill in the art.

### DEFINITIONS

“Optional” or “optionally” means that the subsequently described event or circumstance may or may not occur, and that the description includes instances where said event or circumstance occurs and instances where it does not. For example, the phrase “the medium can optionally contain glucose” means that the medium may or may not contain glucose as an ingredient and that the description includes both media containing glucose and media not containing glucose.

“About” means a referenced numeric indication plus or minus 10% of that referenced numeric indication. For example, the term about 4 would include a range of 3.6 to 4.4.

“GPS” (Global Positioning Satellite) locators are well know in the prior art. Processors within small GPS signal receivers triangulate or otherwise convert information from satellites in orbit around the earth to provide relatively accurate positioning coordinates. Thus a microprocessor chip containing a GPS receiver provides position coordinates in realtime for the instantaneous location of the chip. One example of the present use of such chips (hereinafter “GPS chips”) is within cellular phones or other electronic devices, such as IPADS®, tablets, notepads, computers, and the like, thus enabling tracking of the device.

“GSM” (Global System for Mobile Communications) is a standard set to describe protocols for digital cellular networks used by mobile phones. The coverage area of each cell varies according to the implementation environment. One of the key features of GSM is the Subscriber Identity Module, commonly known as a SIM card. The “SIM” is a detachable smart card containing the user's subscription information and phone book. This allows the user to retain his or her information after switching handsets. Alternatively, the user can also change operators while retaining the handset simply by changing the SIM. Some operators will block this by allowing the phone to use only a single SIM, or only a SIM issued by them; this practice is known as SIM locking.

“REIT” refers to a Real Estate Investment Trust, a corporation, trust or association organized under the U.S. Federal Internal Revenue Code, section 856, et al., that acts as an investment agent specializing in real estate and real estate mortgages. A REIT owns and usually operates income-producing real estate, wherein 90% of its taxable income is distributed to its shareholders annually. In addition to the U.S., many countries have established REIT types of investment systems.

A “cooperative” (aka, “coop”) is an autonomous association of persons who voluntarily cooperate for their mutual, social, economic, and cultural benefit. Agricultural cooperatives or farmers' cooperatives are cooperatives where farmers pool their resources for mutual economic benefit. Agricultural cooperatives can be agricultural service cooperatives, which provide various services to their individual farming members, and agricultural production cooperatives, where production resources such as land or machinery are pooled and members farm jointly. Agricultural supply cooperatives are more common and aggregate purchases, storage, and distribution of farm inputs for their members. By taking advantage of volume discounts and utilizing other economies of scale, supply cooperatives bring down members' costs. Supply cooperatives may provide seeds, fertilizers, chemicals, fuel, and farm machinery. Some supply cooperatives also operate machinery pools that provide mechanical field services (e.g., plowing, harvesting) to their members.

“System Manager” or “Manager” is used interchangeably to refer to the management of one or more entities, such as a farm, a pretreatment plant, a REIT, a cooperative, an association, or the like that exerts control over the one or more entities and any electronic communication or computer systems that are used to calculate and predict strategies to make decisions regarding the operation of the one or more entities. The manager can be one person or a plurality of decision makers.

“Bioproduct” is used herein to include biofuels, chemicals, compounds suitable as liquid fuels, gaseous fuels, triacylglycerols (TAGs), reagents, chemical feedstocks, chemical additives, processing aids, food additives, bioplastics and precursors to bioplastics, and other products made with substances derived from bioresources. Examples of bioproducts include but are not limited to 1,4 diacids (succinic, fumaric and malic), 2,5 furan dicarboxylic acid, 3 hydroxy propionic acid, aspartic acid, glucaric acid, glutamic acid, itaconic acid, levulinic acid, 3-hydroxybutyrolactone, glycerol, sorbitol, xylitol/arabinitol, butanediol, butanol, methane, methanol, ethane, ethene, ethanol, n-propane, 1-propene, 1-propanol, propanal, acetone, propionate, n-butane, 1-butene, 1-butanol, butanal, butanoate, isobutanal, isobutanol, 2-methylbutanal, 2-methylbutanol, 3-methylbutanal, 3-methylbutanol, 2-butene, 2-butanol, 2-butanone, 2,3-butanediol, 3-hydroxy-2-butanone, 2,3-butanedione, ethylbenzene, ethenylbenzene, 2-phenylethanol, phenylacetaldehyde, 1-phenylbutane, 4-phenyl-1-butene, 4-phenyl-2-butene, 1-phenyl-2-butene, 1-phenyl-2-butanol, 4-phenyl-2-butanol, 1-phenyl-2-butanone, 4-phenyl-2-butanone, 1-phenyl-2,3-butandiol, 1-phenyl-3-hydroxy-2-butanone, 4-phenyl-3-hydroxy-2-butanone, 1-phenyl-2,3-butanedione, n-pentane, ethylphenol, ethenylphenol, 2-(4-hydroxyphenyl)ethanol, 4-hydroxyphenylacetaldehyde, 1-(4-hydroxyphenyl) butane, 4-(4-hydroxyphenyl)-1-butene, 4-(4-hydroxyphenyl)-2-butene, 1-(4-hydroxyphenyl)-1-butene, 1-(4-hydroxyphenyl)-2-butanol, 4-(4-hydroxyphenyl)-2-butanol, 1-(4-hydroxyphenyl)-2-butanone, 4-(4-hydroxyphenyl)-2-butanone, 1-(4-hydroxyphenyl)-2,3-butandiol, 1-(4-hydroxyphenyl)-3-hydroxy-2-butanone, 4-(4-hydroxyphenyl)-3-hydroxy-2-butanone, 1-(4-hydroxyphenyl)-2,3-butanonedione, indolylethane, indolylethene, 2-(indole-3-)ethanol, n-pentane, 1-pentene, 1-pentanol, pentanal, pentanoate, 2-pentene, 2-pentanol, 3-pentanol, 2-pentanone, 3-pentanone, 4-methylpentanal, 4-methylpentanol, 2,3-pentanediol, 2-hydroxy-3-pentanone, 3-hydroxy-2-pentanone, 2,3-pentanedione, 2-methylpentane, 4-methyl-1-pentene, 4-methyl-2-pentene, 4-methyl-3-pentene, 4-methyl-2-pentanol, 2-methyl-3-pentanol, 4-methyl-2-pentanone, 2-methyl-3-pentanone, 4-methyl-2,3-pentanediol, 4-methyl-2-hydroxy-3-pentanone, 4-methyl-3-hydroxy-2-pentanone, 4-methyl-2,3-pentanedione, 1-phenylpentane, 1-phenyl-1-pentene, 1-phenyl-2-pentene, 1-phenyl-3-pentene, 1-phenyl-2-pentanol, 1-phenyl-3-pentanol, 1-phenyl-2-pentanone, 1-phenyl-3-pentanone, 1-phenyl-2,3-pentanediol, 1-phenyl-2-hydroxy-3-pentanone, 1-phenyl-3-hydroxy-2-pentanone, 1-phenyl-2,3-pentanedione, 4-methyl-1-phenylpentane, 4-methyl-1-phenyl-1-pentene, 4-methyl-1-phenyl-2-pentene, 4-methyl-1-phenyl-3-pentene, 4-methyl-1-phenyl-3-pentanol, 4-methyl-1-phenyl-2-pentanol, 4-methyl-1-phenyl-3-pentanone, 4-methyl-1-phenyl-2-pentanone, 4-methyl-1-phenyl-2,3-pentanediol, 4-methyl-1-phenyl-2,3-pentanedione, 4-methyl-1-phenyl-3-hydroxy-2-pentanone, 4-methyl-1-phenyl-2-hydroxy-3-pentanone, 1-(4-hydroxyphenyl)pentane, 1-(4-hydroxyphenyl)-1-pentene, 1-(4-hydroxyphenyl)-2-pentene, 1-(4-hydroxyphenyl)-3-pentene, 1-(4-hydroxyphenyl)-2-pentanol, 1-(4-hydroxyphenyl)-3-pentanol, 1-(4-hydroxyphenyl)-2-pentanone, 1-(4-hydroxyphenyl)-3-pentanone, 1-(4-hydroxyphenyl)-2,3-pentanediol, 1-(4-hydroxyphenyl)-2-hydroxy-3-pentanone, 1-(4-hydroxyphenyl)-3-hydroxy-2-pentanone, 1-(4-hydroxyphenyl)-2,3-pentanedione, 4-methyl-1-(4-hydroxyphenyl)pentane, 4-methyl-1-(4-hydroxyphenyl)-2-pentene, 4-methyl-1-(4-hydroxyphenyl)-3-pentene, 4-methyl-1-(4-hydroxyphenyl)-1-pentene, 4-methyl-1-(4-hydroxyphenyl)-3-pentanol, 4-methyl-1-(4-hydroxyphenyl)-2-pentanol, 4-methyl-1-(4-hydroxyphenyl)-3-pentanone, 4-methyl-1-(4-hydroxyphenyl)-2-pentanone, 4-methyl-1-(4-hydroxyphenyl)-2,3-pentanediol, 4-methyl-1-(4-hydroxyphenyl)-2,3-pentanedione, 4-methyl-1-(4-hydroxyphenyl)-3-hydroxy-2-pentanone, 4-methyl-1-(4-hydroxyphenyl)-2-hydroxy-3-pentanone, 1-indole-3-pentane, 1-(indole-3)-1-pentene, 1-(indole-3)-2-pentene, 1-(indole-3)-3-pentene, 1-(indole-3)-2-pentanol, 1-(indole-3)-3-pentanol, 1-(indole-3)-2-pentanone, 1-(indole-3)-3-pentanone, 1-(indole-3)-2,3-pentanediol, 1-(indole-3)-2-hydroxy-3-pentanone, 1-(indole-3)-3-hydroxy-2-pentanone, 1-(indole-3)-2,3-pentanedione, 4-methyl-1-(indole-3-)pentane, 4-methyl-1-(indole-3)-2-pentene, 4-methyl-1-(indole-3)-3-pentene, 4-methyl-1-(indole-3)-1-pentene, 4-methyl-2-(indole-3)-3-pentanol, 4-methyl-1-(indole-3)-2-pentanol, 4-methyl-1-(indole-3)-3-pentanone, 4-methyl-1-(indole-3)-2-pentanone, 4-methyl-1-(indole-3)-2,3-pentanediol, 4-methyl-1-(indole-3)-2,3-pentanedione, 4-methyl-1-(indole-3)-3-hydroxy-2-pentanone, 4-methyl-1-(indole-3)-2-hydroxy-3-pentanone, n-hexane, 1-hexene, 1-hexanol, hexanal, hexanoate, 2-hexene, 3-hexene, 2-hexanol, 3-hexanol, 2-hexanone, 3-hexanone, 2,3-hexanediol, 2,3-hexanedione, 3,4-hexanediol, 3,4-hexanedione, 2-hydroxy-3-hexanone, 3-hydroxy-2-hexanone, 3-hydroxy-4-hexanone, 4-hydroxy-3-hexanone, 2-methylhexane, 3-methylhexane, 2-methyl-2-hexene, 2-methyl-3-hexene, 5-methyl-1-hexene, 5-methyl-2-hexene, 4-methyl-1-hexene, 4-methyl-2-hexene, 3-methyl-3-hexene, 3-methyl-2-hexene, 3-methyl-1-hexene, 2-methyl-3-hexanol, 5-methyl-2-hexanol, 5-methyl-3-hexanol, 2-methyl-3-hexanone, 5-methyl-2-hexanone, 5-methyl-3-hexanone, 2-methyl-3,4-hexanediol, 2-methyl-3,4-hexanedione, 5-methyl-2,3-hexanediol, 5-methyl-2,3-hexanedione, 4-methyl-2,3-hexanediol, 4-methyl-2,3-hexanedione, 2-methyl-3-hydroxy-4-hexanone, 2-methyl-4-hydroxy-3-hexanone, 5-methyl-2-hydroxy-3-hexanone, 5-methyl-3-hydroxy-2-hexanone, 4-methyl-2-hydroxy-3-hexanone, 4-methyl-3-hydroxy-2-hexanone, 2,5-dimethylhexane, 2,5-dimethyl-2-hexene, 2,5-dimethyl-3-hexene, 2,5-dimethyl-3-hexanol, 2,5-dimethyl-3-hexanone, 2,5-dimethyl-3,4-hexanediol, 2,5-dimethyl-3,4-hexanedione, 2,5-dimethyl-3-hydroxy-4-hexanone, 5-methyl-1-phenylhexane, 4-methyl-1-phenylhexane, 5-methyl-1-phenyl-1-hexene, 5-methyl-1-phenyl-2-hexene, 5-methyl-1-phenyl-3-hexene, 4-methyl-1-phenyl-1-hexene, 4-methyl-1-phenyl-2-hexene, 4-methyl-1-phenyl-3-hexene, 5-methyl-1-phenyl-2-hexanol, 5-methyl-1-phenyl-3-hexanol, 4-methyl-1-phenyl-2-hexanol, 4-methyl-1-phenyl-3-hexanol, 5-methyl-1-phenyl-2-hexanone, 5-methyl-1-phenyl-3-hexanone, 4-methyl-1-phenyl-2-hexanone, 4-methyl-1-phenyl-3-hexanone, 5-methyl-1-phenyl-2,3-hexanediol, 4-methyl-1-phenyl-2,3-hexanediol, 5-methyl-1-phenyl-3-hydroxy-2-hexanone, 5-methyl-1-phenyl-2-hydroxy-3-hexanone, 4-methyl-1-phenyl-3-hydroxy-2-hexanone, 4-methyl-1-phenyl-2-hydroxy-3-hexanone, 5-methyl-1-phenyl-2,3-hexanedione, 4-methyl-1-phenyl-2,3-hexanedione, 4-methyl-1-(4-hydroxyphenyl)hexane, 5-methyl-1-(4-hydroxyphenyl)-1-hexene, 5-methyl-1-(4-hydroxyphenyl)-2-hexene, 5-methyl-1-(4-hydroxyphenyl)-3-hexene, 4-methyl-1-(4-hydroxyphenyl)-1-hexene, 4-methyl-1-(4-hydroxyphenyl)-2-hexene, 4-methyl-1-(4-hydroxyphenyl)-3-hexene, 5-methyl-1-(4-hydroxyphenyl)-2-hexanol, 5-methyl-1-(4-hydroxyphenyl)-3-hexanol, 4-methyl-1-(4-hydroxyphenyl)-2-hexanol, 4-methyl-1-(4-hydroxyphenyl)-3-hexanol, 5-methyl-1-(4-hydroxyphenyl)-2-hexanone, 5-methyl-1-(4-hydroxyphenyl)-3-hexanone, 4-methyl-1-(4-hydroxyphenyl)-2-hexanone, 4-methyl-1-(4-hydroxyphenyl)-3-hexanone, 5-methyl-1-(4-hydroxyphenyl)-2,3-hexanediol, 4-methyl-1-(4-hydroxyphenyl)-2,3-hexanediol, 5-methyl-1-(4-hydroxyphenyl)-3-hydroxy-2-hexanone, 5-methyl-1-(4-hydroxyphenyl)-2-hydroxy-3-hexanone, 4-methyl-1-(4-hydroxyphenyl)-3-hydroxy-2-hexanone, 4-methyl-1-(4-hydroxyphenyl)-2-hydroxy-3-hexanone, 5-methyl-1-(4-hydroxyphenyl)-2,3-hexanedione, 4-methyl-1-(4-hydroxyphenyl)-2,3-hexanedione, 4-methyl-1-(indole-3-)hexane, 5-methyl-1-(indole-3)-1-hexene, 5-methyl-1-(indole-3)-2-hexene, 5-methyl-1-(indole-3)-3-hexene, 4-methyl-1-(indole-3)-1-hexene, 4-methyl-1-(indole-3)-2-hexene, 4-methyl-1-(indole-3)-3-hexene, 5-methyl-1-(indole-3)-2-hexanol, 5-methyl-1-(indole-3)-3-hexanol, 4-methyl-1-(indole-3)-2-hexanol, 4-methyl-1-(indole-3)-3-hexanol, 5-methyl-1-(indole-3)-2-hexanone, 5-methyl-1-(indole-3)-3-hexanone, 4-methyl-1-(indole-3)-2-hexanone, 4-methyl-1-(indole-3)-3-hexanone, 5-methyl-1-(indole-3)-2,3-hexanediol, 4-methyl-1-(indole-3)-2,3-hexanediol, 5-methyl-1-(indole-3)-3-hydroxy-2-hexanone, 5-methyl-1-(indole-3)-2-hydroxy-3-hexanone, 4-methyl-1-(indole-3)-3-hydroxy-2-hexanone, 4-methyl-1-(indole-3)-2-hydroxy-3-hexanone, 5-methyl-1-(indole-3)-2,3-hexanedione, 4-methyl-1-(indole-3)-2,3-hexanedione, n-heptane, 1-heptene, 1-heptanol, heptanal, heptanoate, 2-heptene, 3-heptene, 2-heptanol, 3-heptanol, 4-heptanol, 2-heptanone, 3-heptanone, 4-heptanone, 2,3-heptanediol, 2,3-heptanedione, 3,4-heptanediol, 3,4-heptanedione, 2-hydroxy-3-heptanone, 3-hydroxy-2-heptanone, 3-hydroxy-4-heptanone, 4-hydroxy-3-heptanone, 2-methylheptane, 3-methylheptane, 6-methyl-2-heptene, 6-methyl-3-heptene, 2-methyl-3-heptene, 2-methyl-2-heptene, 5-methyl-2-heptene, 5-methyl-3-heptene, 3-methyl-3-heptene, 2-methyl-3-heptanol, 2-methyl-4-heptanol, 6-methyl-3-heptanol, 5-methyl-3-heptanol, 3-methyl-4-heptanol, 2-methyl-3-heptanone, 2-methyl-4-heptanone, 6-methyl-3-heptanone, 5-methyl-3-heptanone, 3-methyl-4-heptanone, 2-methyl-3,4-heptanediol, 2-methyl-3,4-heptanedione, 6-methyl-3,4-heptanediol, 6-methyl-3,4-heptanedione, 5-methyl-3,4-heptanediol, 5-methyl-3,4-heptanedione, 2-methyl-3-hydroxy-4-heptanone, 2-methyl-4-hydroxy-3-heptanone, 6-methyl-3-hydroxy-4-heptanone, 6-methyl-4-hydroxy-3-heptanone, 5-methyl-3-hydroxy-4-heptanone, 5-methyl-4-hydroxy-3-heptanone, 2,6-dimethylheptane, 2,5-dimethylheptane, 2,6-dimethyl-2-heptene, 2,6-dimethyl-3-heptene, 2,5-dimethyl-2-heptene, 2,5-dimethyl-3-heptene, 3,6-dimethyl-3-heptene, 2,6-dimethyl-3-heptanol, 2,6-dimethyl-4-heptanol, 2,5-dimethyl-3-heptanol, 2,5-dimethyl-4-heptanol, 2,6-dimethyl-3,4-heptanediol, 2,6-dimethyl-3,4-heptanedione, 2,5-dimethyl-3,4-heptanediol, 2,5-dimethyl-3,4-heptanedione, 2,6-dimethyl-3-hydroxy-4-heptanone, 2,6-dimethyl-4-hydroxy-3-heptanone, 2,5-dimethyl-3-hydroxy-4-heptanone, 2,5-dimethyl-4-hydroxy-3-heptanone, n-octane, 1-octene, 2-octene, 1-octanol, octanal, octanoate, 3-octene, 4-octene, 4-octanol, 4-octanone, 4,5-octanediol, 4,5-octanedione, 4-hydroxy-5-octanone, 2-methyloctane, 2-methyl-3-octene, 2-methyl-4-octene, 7-methyl-3-octene, 3-methyl-3-octene, 3-methyl-4-octene, 6-methyl-3-octene, 2-methyl-4-octanol, 7-methyl-4-octanol, 3-methyl-4-octanol, 6-methyl-4-octanol, 2-methyl-4-octanone, 7-methyl-4-octanone, 3-methyl-4-octanone, 6-methyl-4-octanone, 2-methyl-4,5-octanediol, 2-methyl-4,5-octanedione, 3-methyl-4,5-octanediol, 3-methyl-4,5-octanedione, 2-methyl-4-hydroxy-5-octanone, 2-methyl-5-hydroxy-4-octanone, 3-methyl-4-hydroxy-5-octanone, 3-methyl-5-hydroxy-4-octanone, 2,7-dimethyloctane, 2,7-dimethyl-3-octene, 2,7-dimethyl-4-octene, 2,7-dimethyl-4-octanol, 2,7-dimethyl-4-octanone, 2,7-dimethyl-4,5-octanediol, 2,7-dimethyl-4,5-octanedione, 2,7-dimethyl-4-hydroxy-5-octanone, 2,6-dimethyloctane, 2,6-dimethyl-3-octene, 2,6-dimethyl-4-octene, 3,7-dimethyl-3-octene, 2,6-dimethyl-4-octanol, 3,7-dimethyl-4-octanol, 2,6-dimethyl-4-octanone, 3,7-dimethyl-4-octanone, 2,6-dimethyl-4,5-octanediol, 2,6-dimethyl-4,5-octanedione, 2,6-dimethyl-4-hydroxy-5-octanone, 2,6-dimethyl-5-hydroxy-4-octanone, 3,6-dimethyloctane, 3,6-dimethyl-3-octene, 3,6-dimethyl-4-octene, 3,6-dimethyl-4-octanol, 3,6-dimethyl-4-octanone, 3,6-dimethyl-4,5-octanediol, 3,6-dimethyl-4,5-octanedione, 3,6-dimethyl-4-hydroxy-5-octanone, n-nonane, 1-nonene, 1-nonanol, nonanal, nonanoate, 2-methylnonane, 2-methyl-4-nonene, 2-methyl-5-nonene, 8-methyl-4-nonene, 2-methyl-5-nonanol, 8-methyl-4-nonanol, 2-methyl-5-nonanone, 8-methyl-4-nonanone, 8-methyl-4,5-nonanediol, 8-methyl-4,5-nonanedione, 8-methyl-4-hydroxy-5-nonanone, 8-methyl-5-hydroxy-4-nonanone, 2,8-dimethylnonane, 2,8-dimethyl-3-nonene, 2,8-dimethyl-4-nonene, 2,8-dimethyl-5-nonene, 2,8-dimethyl-4-nonanol, 2,8-dimethyl-5-nonanol, 2,8-dimethyl-4-nonanone, 2,8-dimethyl-5-nonanone, 2,8-dimethyl-4,5-nonanediol, 2,8-dimethyl-4,5-nonanedione, 2,8-dimethyl-4-hydroxy-5-nonanone, 2,8-dimethyl-5-hydroxy-4-nonanone, 2,7-dimethylnonane, 3,8-dimethyl-3-nonene, 3,8-dimethyl-4-nonene, 3,8-dimethyl-5-nonene, 3,8-dimethyl-4-nonanol, 3,8-dimethyl-5-nonanol, 3,8-dimethyl-4-nonanone, 3,8-dimethyl-5-nonanone, 3,8-dimethyl-4,5-nonanediol, 3,8-dimethyl-4,5-nonanedione, 3,8-dimethyl-4-hydroxy-5-nonanone, 3,8-dimethyl-5-hydroxy-4-nonanone, n-decane, 1-decene, 1-decanol, decanoate, 2,9-dimethyldecane, 2,9-dimethyl-3-decene, 2,9-dimethyl-4-decene, 2,9-dimethyl-5-decanol, 2,9-dimethyl-5-decanone, 2,9-dimethyl-5,6-decanediol, 2,9-dimethyl-6-hydroxy-5-decanone, 2,9-dimethyl-5,6-decanedionen-undecane, 1-undecene, 1-undecanol, undecanal, undecanoate, n-dodecane, 1-dodecene, 1-dodecanol, dodecanal, dodecanoate, n-dodecane, 1-decadecene, n-tridecane, 1-tridecene, 1-tridecanol, tridecanal, tridecanoate, n-tetradecane, 1-tetradecene, 1-tetradecanol, tetradecanal, tetradecanoate, n-pentadecane, 1-pentadecene, 1-pentadecanol, pentadecanal, pentadecanoate, n-hexadecane, 1-hexadecene, 1-hexadecanol, hexadecanal, hexadecanoate, n-heptadecane, 1-heptadecene, 1-heptadecanol, heptadecanal, heptadecanoate, n-octadecane, 1-octadecene, 1-octadecanol, octadecanal, octadecanoate, n-nonadecane, 1-nonadecene, 1-nonadecanol, nonadecanal, nonadecanoate, eicosane, 1-eicosene, 1-eicosanol, eicosanal, eicosanoate, 3-hydroxy propanal, 1,3-propanediol, 4-hydroxybutanal, 1,4-butanediol, 3-hydroxy-2-butanone, 2,3-butandiol, 1,5-pentane diol, homocitrate, homoisocitorate, b-hydroxy adipate, glutarate, glutarsemialdehyde, glutaraldehyde, 2-hydroxy-1-cyclopentanone, 1,2-cyclopentanediol, cyclopentanone, cyclopentanol, (S)-2-acetolactate, (R)-2,3-Dihydroxy-isovalerate, 2-oxoisovalerate, isobutyryl-CoA, isobutyrate, isobutyraldehyde, 5-amino pentaldehyde, 1,10-diaminodecane, 1,10-diamino-5-decene, 1,10-diamino-5-hydroxydecane, 1,10-diamino-5-decanone, 1,10-diamino-5,6-decanediol, 1,10-diamino-6-hydroxy-5-decanone, phenylacetoaldehyde, 1,4-diphenylbutane, 1,4-diphenyl-1-butene, 1,4-diphenyl-2-butene, 1,4-diphenyl-2-butanol, 1,4-diphenyl-2-butanone, 1,4-diphenyl-2,3-butanediol, 1,4-diphenyl-3-hydroxy-2-butanone, 1-(4-hydeoxyphenyl)-4-phenylbutane, 1-(4-hydeoxyphenyl)-4-phenyl-1-butene, 1-(4-hydeoxyphenyl)-4-phenyl-2-butene, 1-(4-hydeoxyphenyl)-4-phenyl-2-butanol, 1-(4-hydeoxyphenyl)-4-phenyl-2-butanone, 1-(4-hydeoxyphenyl)-4-phenyl-2,3-butanediol, 1-(4-hydeoxyphenyl)-4-phenyl-3-hydroxy-2-butanone, 1-(indole-3)-4-phenylbutane, 1-(indole-3)-4-phenyl-1-butene, 1-(indole-3)-4-phenyl-2-butene, 1-(indole-3)-4-phenyl-2-butanol, 1-(indole-3)-4-phenyl-2-butanone, 1-(indole-3)-4-phenyl-2,3-butanediol, 1-(indole-3)-4-phenyl-3-hydroxy-2-butanone, 4-hydroxyphenylacetoaldehyde, 1,4-di(4-hydroxyphenyl)butane, 1,4-di(4-hydroxyphenyl)-1-butene, 1,4-di(4-hydroxyphenyl)-2-butene, 1,4-di(4-hydroxyphenyl)-2-butanol, 1,4-di(4-hydroxyphenyl)-2-butanone, 1,4-di(4-hydroxyphenyl)-2,3-butanediol, 1,4-di(4-hydroxyphenyl)-3-hydroxy-2-butanone, 1-(4-hydroxyphenyl)-4-(indole-3-) butane, 1-(4-hydroxyphenyl)-4-(indole-3)-1-butene, 1-di(4-hydroxyphenyl)-4-(indole-3)-2-butene, 1-(4-hydroxyphenyl)-4-(indole-3)-2-butanol, 1-(4-hydroxyphenyl)-4-(indole-3)-2-butanone, 1-(4-hydroxyphenyl)-4-(indole-3)-2,3-butanediol, 1-(4-hydroxyphenyl-4-(indole-3)-3-hydroxy-2-butanone, indole-3-acetoaldehyde, 1,4-di(indole-3-)butane, 1,4-di(indole-3)-1-butene, 1,4-di(indole-3)-2-butene, 1,4-di(indole-3)-2-butanol, 1,4-di(indole-3)-2-butanone, 1,4-di(indole-3)-2,3-butanediol, 1,4-di(indole-3)-3-hydroxy-2-butanone, succinate semialdehyde, hexane-1,8-dicarboxylic acid, 3-hexene-1,8-dicarboxylic acid, 3-hydroxy-hexane-1,8-dicarboxylic acid, 3-hexanone-1,8-dicarboxylic acid, 3,4-hexanediol-1,8-dicarboxylic acid, 4-hydroxy-3-hexanone-1,8-dicarboxylic acid, glycerol, fucoidan, iodine, chlorophyll, carotenoid, calcium, magnesium, iron, sodium, potassium, phosphate, lactic acid, acetic acid, formic acid, isoprenoids, and polyisoprenes, including rubber. Further, such products can include succinic acid, pyruvic acid, enzymes such as cellulases, polysaccharases, lipases, proteases, ligninases, and hemicellulases and may be present as a pure compound, a mixture, or an impure or diluted form. The terms “fermentation end-product” or “fermentive end-product” are used interchangeably to describe a bioproduct made through the process of fermentation.

The term “fermentation” as used herein has its ordinary meaning as known to those skilled in the art and can include culturing of a microorganism or group of microorganisms in or on a suitable medium for the microorganisms. The microorganisms can be aerobes, anaerobes, facultative anaerobes, heterotrophs, autotrophs, photoautotrophs, photoheterotrophs, chemoautotrophs, and/or chemoheterotrophs. The microorganisms can be growing aerobically or anaerobically. They can be in any phase of growth, including lag (or conduction), exponential, transition, stationary, death, dormant, vegetative, sporulating, etc.

“Growth phase” is used herein to describe the type of cellular growth that occurs after the “Initiation phase” and before the “Stationary phase” and the “Death phase.” The growth phase is sometimes referred to as the exponential phase or log phase or logarithmic phase.

The term “plant polysaccharide” as used herein has its ordinary meaning as known to those skilled in the art and can comprise one or more polymers of saccharides and saccharide derivatives as well as derivatives of saccharide polymers and/or other polymeric materials that occur in plant matter. Exemplary plant polysaccharides include lignin, cellulose, starch, pectin, and hemicellulose. Others are chitin, sulfonated polysaccharides such as alginic acid, agarose, carrageenan, porphyran, furcelleran and funoran. Generally, the polysaccharide can have two or more saccharide units or derivatives of saccharide units, while an oligosaccharide can have two to ten saccharide units or derivatives of saccharide units The saccharide units and/or derivatives of saccharide units can repeat in a regular pattern, or otherwise. The saccharide units can be hexose units or pentose units, or combinations of these. The derivatives of saccharide units can be sugar alcohols, sugar acids, amino sugars, etc. The polysaccharides can be linear, branched, cross-linked, or a mixture thereof. One type or class of polysaccharide can be cross-linked to another type or class of polysaccharide.

The term “fermentable saccharides” as used herein has its ordinary meaning as known to those skilled in the art and can include one or more saccharides and/or saccharide derivatives that can be utilized as a carbon source by the microorganism, including monomers, dimers, and polymers of these compounds including two or more of these compounds. In some cases, the organism can break down these polymers, such as by hydrolysis, prior to incorporating the broken down material. Exemplary fermentable saccharides include, but are not limited to glucose, dextrose, xylose, arabinose, galactose, mannose, rhamnose, cellobiose, lactose, sucrose, maltose, and fructose.

The term “biomass” as used herein has its ordinary meaning as known to those skilled in the art and can include one or more biological materials that can be converted into a biofuel, chemical or other product. Biomass as used herein is synonymous with the term “feedstock” and includes corn syrup, molasses, silage, agricultural residues (corn stalks, grass, straw, grain hulls, bagasse, etc.), animal waste (manure from cattle, poultry, and hogs), Distillers Dried Solubles (DDS), Distillers Dried Grains (DDG), Condensed Distillers Solubles (CDS), Distillers Wet Grains (DWG), Distillers Dried Grains with Solubles (DDGS), woody materials (wood or bark, wood chips, sawdust, timber slash, and mill scrap), municipal waste (waste paper, recycled toilet papers, yard clippings, etc.), and energy crops (poplars, willows, Eucalyptus, switchgrass, alfalfa, prairie bluestem, algae, including macroalgae, etc.). One exemplary source of biomass is plant matter. Plant matter can be, for example, woody plant matter, non-woody plant matter, cellulosic material, lignocellulosic material, hemicellulosic material, carbohydrates, pectin, starch, inulin, fructans, glucans, corn, sugar cane, grasses, switchgrass, sorghum, high biomass sorghum, bamboo, algae and material derived from these. Plants can be in their natural state or genetically modified, e.g., to increase the cellulosic or hemicellulosic portion of the cell wall, or to produce additional exogenous or endogenous enzymes to increase the separation of cell wall components. Plant matter can be further described by reference to the chemical species present, such as proteins, polysaccharides and oils. Polysaccharides include polymers of various monosaccharides and derivatives of monosaccharides including glucose, fructose, lactose, galacturonic acid, rhamnose, etc. Plant matter also includes agricultural waste byproducts or side streams such as pomace, corn steep liquor, corn steep solids, distillers grains, peels, pits, fermentation waste, straw, lumber, sewage, garbage and food leftovers. Peels can be citrus which include, but are not limited to, tangerine peel, grapefruit peel, orange peel, tangerine peel, lime peel and lemon peel. These materials can come from farms, including aquatic farms, forestry, industrial sources, households, etc. Materials from processes can also include those from the production of paper, cellulose products, microcrystalline cellulose, and cellulosics. The feedstock can be a side stream or waste stream from a facility that utilizes one or more of these processes on a biomass material, such as cellulosic, hemicellulosic or lignocellulosic material. Examples include paper plants, cellulosics plants, distillation plants, cotton processing plants, and microcrystalline cellulose plants. The feedstock can also include cellulose-containing or cellulosic containing waste materials. The feedstock can also be biomass materials, such as wood, grasses, corn, starch, or saccharide, produced or harvested as an intended feedstock for production of ethanol or other products such as by biocatalysts.

Another non-limiting example of biomass is animal matter, including, for example milk, meat, fat, animal processing waste, and animal waste. Biomass can include cell or tissue cultures; for example, biomass can include plant cell culture(s) or plant tissue culture(s). “Biomass resource” is used to refer to biomass to be supplied for a process, such as those described herein.

The term “biocatalyst” as used herein has its ordinary meaning as known to those skilled in the art and can include one or more enzymes and/or microorganisms, including solutions, suspensions, and mixtures of enzymes and microorganisms. In some contexts this word will refer to the possible use of either enzymes or microorganisms to serve a particular function, in other contexts the word will refer to the combined use of the two, and in other contexts the word will refer to only one of the two. The context of the phrase will indicate the meaning intended to one of skill in the art.

“Pretreatment” or “pretreated” is used herein to refer to any mechanical, chemical, thermal, biochemical process or combination of these processes whether in a combined step or performed sequentially, that achieves disruption or expansion of the biomass so the saccharides are released and/or depolymerized to monomeric sugars. In one embodiment, pretreatment includes removal or disruption of lignin so as to make the cellulose and hemicellulose polymers in the plant biomass more available to cellulolytic and/or hemicellulolytic enzymes and/or microbes, for example, by treatment with acid or base. In one embodiment, pretreatment includes disruption or expansion of cellulosic and/or hemicellulosic material. Steam explosion, and ammonia fiber expansion (or explosion) (AFEX) are well known thermal/chemical techniques. Hydrolysis, including methods that utilize acids, bases, and/or enzymes can be used. Other thermal, chemical, biochemical, enzymatic techniques can also be used. Pretreatment can also include processes to assist the release or extraction of oils from algal, plant or microbial cellular materials.

“Saccharide compounds” or “saccharide streams” is used herein to indicate mostly monosaccharide saccharides, dissolved, crystallized, evaporated, or partially dissolved, including but not limited to hexoses and pentoses; sugar alcohols; sugar acids; sugar amines; compounds containing two or more of these linked together directly or indirectly through covalent or ionic bonds; and mixtures thereof. Included within this description are disaccharides; trisaccharides; oligosaccharides; polysaccharides; and saccharide chains, branched and/or linear, of any length. A saccharide stream can consist of primarily or substantially C6 saccharides, C5 saccharides, or mixtures of both C6 and C5 saccharides in varying ratios of said saccharides. C6 saccharides have a six-carbon molecular backbone and C5 saccharides have a five-carbon molecular backbone.

“Saccharide polymer” is used herein to indicate a saccharide that contains two or more saccharide residues or units or derivatives of saccharide units. In one embodiment, a saccharide polymer can be soluble. In one embodiment, a saccharide polymer can be soluble in an aqueous medium. In some embodiments, the saccharide polymer comprises 2 to 10 saccharide residues or units. In some embodiments, the saccharide polymers comprise 2 to 10 or 2 to 20, 2 to 30, 2 to 40, 2 to 50, 2 to 60, 2 to 70, 2 to 80, 2 to 90, or 2 to 100 saccharide residues or units. In some embodiments, the saccharide polymers comprise more than 2 saccharide residues. In some embodiments, the saccharide polymers comprise 2 saccharide residues. In some embodiments, the saccharide polymers comprise less than 10 saccharide residues. In some embodiments, the saccharide polymers comprise more than 10 saccharide residues. In some embodiments, the saccharide polymers comprise disaccharides, trisaccharides, tetrasaccharides, pentasaccharides, hexasaccharides, heptasaccharides, octasaccharides, enneasaccharides, and/or decasaccharides.

The following description and examples illustrate some exemplary embodiments of the disclosure in detail. Those of skill in the art will recognize that there are numerous variations and modifications of this disclosure that are encompassed by its scope. Accordingly, the description of a certain exemplary embodiment should not be deemed to limit the scope of the present disclosure.

### INTRODUCTION

Nearly all biofuels and biochemicals (biobased products) are made from saccharide-based feedstocks. The sugars from food crops, such as corn, sugar beets and sugarcane are easy to extract and convert, making large-scale production profitable. However, the price of these commodities fluctuates wildly and, as demand grows, costs of these bioresources will eventually make such systems too expensive. Further, there is much criticism of using food crops for fuels and many countries have restricted such use. To compete with petroleum-based fuels and chemicals, biomass needs to be abundant, inexpensive, and the transportation costs need to be low.

To avoid the use of food crops, methods have been developed to extract sugars from lignocellulosic and cellulosic biomass. These feedstocks can be harvested from anywhere they are grown or stored and are processed for their sugars derived from polymers such as starch, cellulose, hemicellulose and other carbohydrates. The commodities produced from these carbohydrates are the result of many different physical and chemical processes, which can involve many stages of refinement. Ultimately, the cost of the feedstock and the process to synthesize a particular chemical will determine the cost of the product. Many of the biofuels and biochemicals made today are competing with products derived from fossil fuels. To compete competitively in the marketplace, it is necessary to optimize the selection and consumption of feedstock, as well as the handling and processing of feedstocks and the sugars produced from them.

Feedstock is the largest complement in the cost of cellulosic ethanol. The high yield of genetically-engineered crops and varieties such as energy sorghum can lower feedstock costs substantially. Additionally, inexpensive production costs of semipermanent crops such as switchgrass or miscanthus, or the perennial or semiperennial plants such as poplar, willow and eucalyptus reduce the expense of planting and intense cultivation each year. Co-location of the pretreatment plant and the crop site can also reduce costs as transportation of bulky biomass can be expensive, especially if it has to be shipped many miles to a biofuel or biochemical manufacturer. It is more cost effective to locate one or more pretreatment plants close to where the feedstock is harvested and transport the sugars produced through pretreatment, either in solution or as solids. See, U.S. Pat. No. 8,323,923.

Optimization of Resources

Embodiments of the invention include a cooperative or other system for the use of agricultural land, timberland, or any real estate that has a source of a feedstock for bioproducts. This includes municipal waste sites, aquatic culture of algae, waste from lumber mills, food waste from restaurants, military establishments, and the like.

The land or resource can be owned or leased, or the feedstock itself bargained for in a partial lease or ownership contract as is done by leasing or owning the mineral rights of a land mass. In an aquatic situation, e.g., rights to cultivate macroalgae can be owned or leased, or algal can be cultivated in containers on an owned or leased land mass. The feedstock can comprise one type of cellulosic material, such as sugarcane, bagasse, corn, wheat, wood chips, sorghum, sugar beets, switchgrass, poplar, willow, municipal waste, food waste, or it can comprise a combination of feedstocks. If it is certain algal species, it is understood that oils can be extracted as well.

The system itself is expected to comprise one or more sources of feedstock. As an example, it can be a REIT, cooperative, or other organization that owns (or leases) and controls two or more farms. The particular crops to be grown are determined by the REIT or cooperative and in accordance with feedback from the pretreatment facility and/or the biochemical manufacturer. In one embodiment, the feedstock resources and the pretreatment facility may be owned or leased by the same REIT or cooperative. In another embodiment, the biochemical plant can be owned or leased by the same REIT or cooperative as well. What is important is that there is a system in place to automatically assess factors affecting the production costs and availability of the feedstock resource in conjunction with the needs of the pretreatment facility that produces sugars from the feedstock. In addition, factors that affect the synthesis or fermentation of a bioproduct at one or more biochemical plants can be used for feedback and control as well. To date, only systems involving a particular agricultural parameter or a single agronomic system have been considered for management plans. See, e.g., U.S. Pat. Nos. 6,990,459, 7,930,085, 7,218,975, and 8,024,074 which are hereby incorporated by reference in their entireties. There have also been systems described that considered prediction of the price of natural resources, e.g., U.S. Pat. No. 8,086,354. However, none of these systems considers a feedback system using a manager that controls production and distribution of resources based partly on feedback of an industrial consumer.

In the embodiments that follow, a REIT is specifically mentioned because this entity has the capability to own and operate both resource commodities and industrial real estate such a pretreatment plants. Even if the pretreatment facilities are not owned or controlled by a REIT, this type of investment trust has the management structure required to operate a resource entity and coordinate its activities with other industries. One of skill in the art can appreciate that this system can be applied to a bioresource such as an algal or microorganism bioresource, but for purposes of illustration, the embodiments provided herein describe saccharide-based bioproducts.

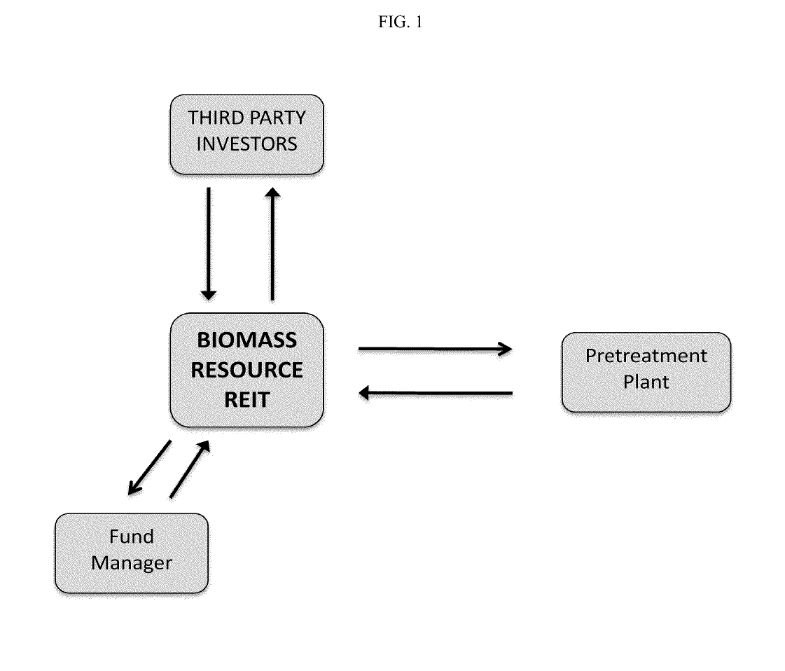

The structure of a REIT is shown in FIG. 1. REITs are a specialized form of real estate ownership, wherein third party investors, normally more than 100, provide the capital that allows them ownership of a portion of a group of real estate properties. If the real estate is operated to provide a biomass resource, it can be farmland, timberland, municipal waste sites, aquatic (including oceanic) farms or the like, and produces a saccharide-containing feedstock for sugar extraction. While the investors provide the capital for the purchase and operation of a REIT, they are not usually active investors. The real estate is owned as a trust and the profits are returned to the investors annually. Because of their access to corporate-level debt and equity that typical real estate owners cannot access, REITs have a favorable capital structure and are able to use this capital to finance tenant improvement costs and leasing commissions that less capitalized owners cannot afford. A REIT is often managed by a board of directors or trustees (Fund Manager), who can appoint a manager or a management company to oversee the operation of the real estate functions. Through the manager or the board, the REIT can interact with one or more pretreatment operations (or the operation could be carried out at the REIT real estate site). For example, the REIT can guarantee to sell a present or future farmland biomass commodity at a certain price and guarantee a minimum amount of the commodity to the pretreatment plant. Similarly, the pretreatment facility can guarantee to offtake a particular amount of the REIT's biomass resource at a set price.

In one embodiment of this invention, it is expected that the system used to gather data, receive feedback, and predict the distribution of feedstock resources is an intelligent system that can combine one or more methods to assess many factors, and utilize the feedback for optimization of feedstock production. For example, not to be limited by theory, agricultural crops are subject to the available environmental resources at their location. A GPS locator system can be in place to indicate to the management of the REIT, which crops are receiving adequate rainfall and other weather conditions affecting growth. Nutrient levels can be monitored by sampling which is input directly into a mobile electronic device that transmits the data directly from that location. A centralized system at the REIT can then determine if fertilizer is needed, or if the harvest of the crop should take place earlier or later than planned. If the crop is to be stored, sampled moisture content of the harvested material (in the field or at the storage site) can be taken into account and moisture added or material further dried prior to storage. If the crop is to be taken directly to the pretreatment plant, a report of the moisture content as well as the ratio of starch, lignin, cellulose and hemicellulose can be sent to the pretreatment plant along with the amount of material being shipped. Different feedstocks require different handling and extraction methods. This allows the pretreatment plant to set up the type of mechanical, chemical and enzymatic parameters necessary to extract and hydrolyze the optimal amount of sugars needed from the particular feedstock.

The pretreatment plant can provide feedback to the REIT as to the amount and type of lignocellulosic material they require and the REIT can harvest the exact amount and type of crop for the pretreatment plant. If one or more pretreatment plants are located at or close to the harvest site, calculations to maintain the pretreatment process at maximum capacity can include, but are not limited to: the type and amount of feedstock required for pretreatment at any one time, the time required to transport the feedstock from the field or by truck (or other means), the type of feedstock required, the type and time of pretreatment for a particular feedstock, the weather conditions, the labor requirements, the equipment required, and the chemicals needed.

In addition to pretreatment and feedstocks, the system is designed to accept information from biochemical plants. In a further embodiment, communications can be established between the REIT, the pretreatment plant, and any biochemical plant so that, not only do the pretreatment plants and farms run optimally, but the supply and demand between feedstock type and availability, sugar production, and end-product is optimal as well. If the end-product has a high value with a capacity for a large profit, the expenditures of transportation and refinement of sugars will not factor in as seriously as a low margin end-product, and pretreatment can occur further away (possibly in another country) without seriously affecting the profit margin for all.

One of the advantages of the REIT or cooperative is that with good control over availability of feedstock, instead of year-to-year contracts with farmers who may be reluctant to produce cellulosic bioproduct feedstocks in some years because of high food crop prices, the uncertainty and fluctuations of feedstock availability can be circumvented. Pretreatment plants and/or bioproduct manufacturers can make long term commitments with the feedstock producers. The REIT or cooperative can guarantee the availability of the feedstock commodity needs over several years. Such contracts can allow for fluctuations in the price due to seasonal variations, such as weather, disasters (flooding, tornadoes, locusts, disease, etc.) and be tied to data that is input from the field and calculated based on amount and quality of yield. The system can identify local or temporary minima/maxima, can take a high/low cost indication from the field, monitor historical variations, or use some combination of these source data. For example, following input of field data, a visual, tactile, or audio indicator provides the REIT with information that can indicate whether the current time, or a future time, is economically and/or environmentally optimal for producing the feedstock. Instead of a subjective evaluation to establish the price of a feedstock or sugar product for that time period, data calculations set with the relevant factors can establish the price in the range. In fact, given a period of time, the most relevant factors can be determined and used at other locations as well.

This system can also calculate the type and amount of feedstock to be planted to give the most promising results for a particular product, or to provide the pretreatment plant the best lignocellulosic material for the extraction and refinement of a particular quality of sugar stream. If a new contract is established with an end-producer, embodiments of the invention can comprise systems for locating the best feedstock available within the REIT. These systems can also locate pretreatment plants that have the capacity to produce the quantity and quality of the sugars required by that end-producer.

Other aspects of this invention include the ability of the REIT or cooperative to understand the needs of a farm within the system for the particular feedstock grown. For example, switchgrass and poplar, while perennial (or semiperennial) crops do not need the labor intensive care of corn or sorghum, they will require different harvesting equipment. A system that tracks which feedstock is grown at a particular location can calculate not only the type of equipment needed but when it will be needed, so that more equipment can be efficiently used, thus reducing capital costs. A REIT that has information calculated regarding the labor, chemicals, and equipment necessary over a large amount of agricultural land, is going to more economically manage that land and be in a position to negotiate discounts on capital supplies and equipment.

In one embodiment of this invention, the system can receive input and output from multiple receiving and transmitting devices. For example, probes in the soil or air, can transmit information regarding soil moisture and soil nutrients. GPS locators can indicate the site from which the information is being transmitted and a monitoring system at the REIT receiving site can be triggered remotely, for example, to alert the management to adverse climatic conditions or to trigger an irrigation system to turn on. Monitors with GPS chips or similar devices can indicate the location of trucks delivering feedstock or sugars, or their availability to receive a load. Monitors on sugar streams or pretreatment equipment can alert a manager to a change in processing or the composition of a sugar stream. Systems such as these can be used to automatically respond and trigger, for example, an adjustment of temperature, pH, or other physical/chemical parameter for pretreatment.

In one embodiment, all or portions of this method can be applied to other feedstock resources. Wood, for example, is an abundant feedstock resource but harvesting and mill operations are not usually located near pretreatment or bioproduct plants. Harvesting operations can be scattered throughout forests and woodchips can be found at harvesting sites as well as at the timber or pulp mill sites. With such operations, a plurality of mobile pretreatment plants can be very effective, especially with good communication and monitoring of harvesting sites. Not only can individual trees be tracked, but the harvested logs are large enough to be monitored and tracked individually as they move through the system.

It is understood that the management system of the invention that controls the optimization of resources is not limited to a REIT or cooperative. In the examples given above, a resource entity for such carbohydrate-containing feedstocks or other biomass resources can be anyone who controls (owns, leases, or manages) two or more sites comprising such biomass. These sites can be restaurants, military establishments (including ships), woodlots, municipal waste facilities, ocean or lake sites, farms, timber mills, pulp mills, or the like. Further, the REIT or other resource entity can own or operate the pretreatment plants and/or the end product plant as well.

Certain embodiments of the invention comprise optimizing or arranging consumption or use of one or more resources. The optimization or arrangement for consumption or use of the resources can comprise factors or dimensions other than, or in addition to, those factors or dimensions contained in the resource and product function described infra.

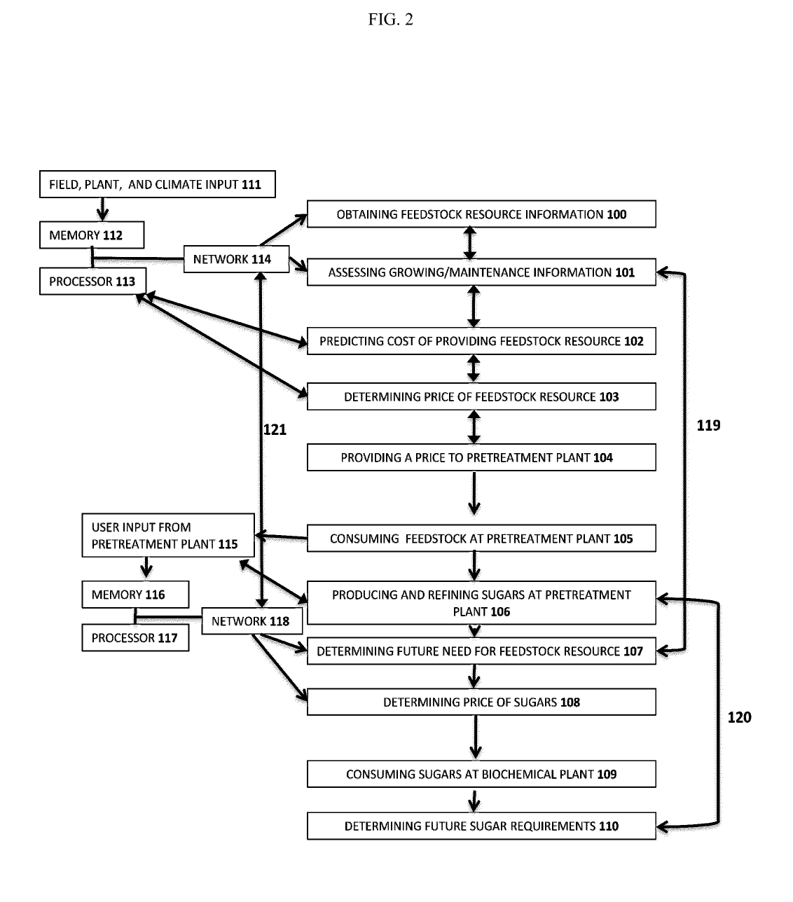

FIG. 2 is a flow diagram for optimizing the operation of a feedstock resource used to produce biofuels and other biochemicals. In accordance with one embodiment of the invention, feedstock information is obtained 100 based on prior information regarding suitability for one or more sugar plant needs, climate information, field and plant growing information for that region. The information can come from many resources 111, including data input from the field, media reports, agricultural reports, and the like. The information is input into a processor 113 with memory storage 112 for this application and future applications. The appropriate crop is sown in accordance with calculations that are sent through a network to the manager of the agricultural land, who controls the planting, farming, and harvesting of the crop 101. Information regarding the crop is also input through the same system 112, 113, as the season and harvesting progress so the information is available to predict the cost of providing the feedstock 102. This information is transmitted via the network to the system manager and used to determine the actual price of the resource 103 so that, with other factors, such as transport and drying costs taken into account, a present or future price of the resource can be provided to a pretreatment plant 104.

A pretreatment plant takes in the feedstock resource delivered to its site and begins the pretreatment process 105 of extracting sugars and refining them from the feedstock 106. During this process, information and data regarding such factors as the time and effort of preparing (chopping, milling, washing, etc.), extraction (pH, time, temperature, pressure, etc.), depolymerization (enzymes, acid), separation (delignification, C5 from C6 sugars, etc.), purification (filtering, ion exchange, etc.), and yields is input into a processor 117 with memory storage 116. The information is used to determine the amount and type of feedstock resource needed in the future 107. This information is transmitted through a network and is also used to calculate the price of sugar product, both present and future 108. On the basis of the quality and quantity of sugar yields, the pretreatment plant gives feedback to the system manager 119 regarding future needs.

The sugars are delivered to a biochemical plant where the sugars are used to produce bioproducts such as ethanol, biobutanol, succinic acid, triacylglycerols, bioplastics, etc. either by physical, chemical, and/or fermentation processes 109. On the basis of consumption and yield, the biochemical plant determines its future sugar requirements 110 and provides this feedback to the pretreatment plant 120.

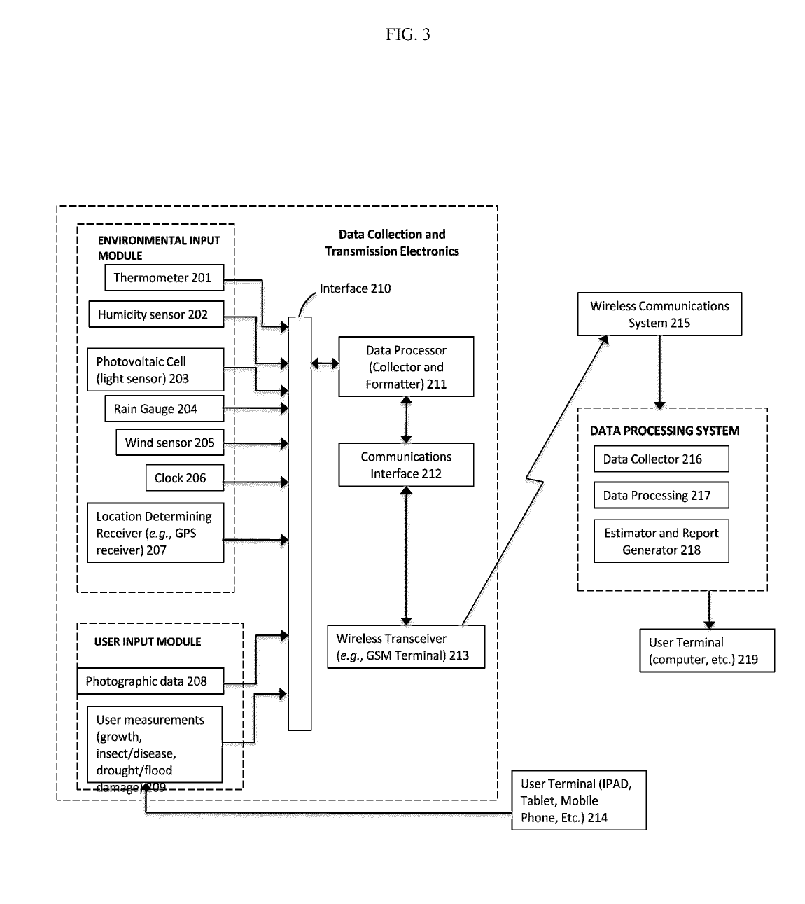

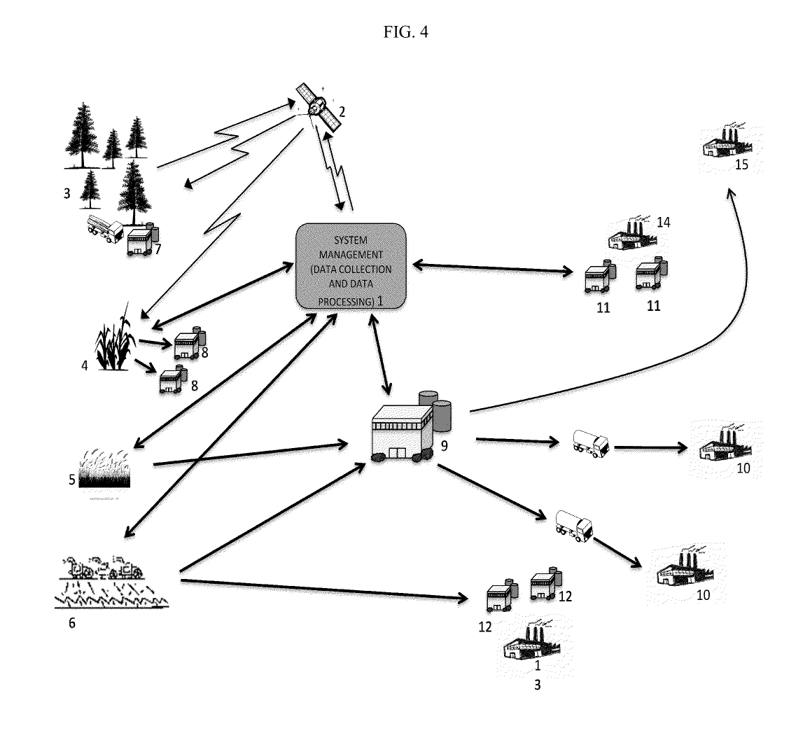

FIG. 4 is an illustrative diagram of the kind of control systems that can be arranged between feedstock resources and pretreatment plants. They involve, as part of the system, wireless communications systems, internet service, vehicle electronics, field sampling and data transmission, plant data input, software to calculate optimized situations and handling of field information, transmission of reports resulting from receipt of data, and controller-type mechanisms. Without being limiting, the system manager 1 (REIT manager(s), owners, cooperative, etc.) is responsible for receiving the input from a feedstock resource (see FIG. 3), collecting the data, determining whether the information to be generated from the data is for present or future needs, which needs to be calculated through the data processor (resource source, pretreatment plant, or manager's), generating the information required, and transmitting that information.

FIG. 3 is a block diagram showing one embodiment of a system for communicating feedstock resource data to a management system for estimating and predicting present and future yields. The environmental input module comprises one or more devices for measuring environmental parameters without a user input. These automatic reading and analytical devices can comprise a field thermometer 201, humidity sensor 202, light sensor 203, rain gauge 204, wind sensor 205, clock 206, and GPS locator 207. The user input module can comprise information that is taken automatically or manually, such as a digital camera for photographic data 208, or information that can require user measurements input electronically 214. The user measurements are recorded electronically in a format that is read electronically into a device 209 that can couple with an interface. Both modules are coupled to the interface 210 via interconnection cables or wireless link (e.g., Blue-tooth link, microwave link, infra-red link, MHz, VHF or UHF communications link, etc.) to facilitate collection of the data. The collected data is transmitted through wireless transceivers. In one embodiment, data processor 211 can facilitate collection of the environmental data and organization of the data, including tracking of the number of samples during a given time period for any defined geographic area. The collector can include a statistical analyzer for performing statistical analysis on the data consistent with the tracked samples per defined geographic area. The formatter can place the data into a desired standard data format for storage in a data storage device (not shown) or transmit via a communications interface 212 and transceiver 213.

The data processor can comprise an embedded processor, a digital signal processor, a microprocessor, a computer, or any other data processor. The interconnections between the data processor and other components indicated by arrows can represent physical data paths (e.g., a databus), logical data paths, or both. Those of skill in the art will know that other configurations are possible to achieve similar results.

The wireless communications system 215 can comprise a commercially available communications system, such as a time-division multiple-access (TDMA) system, a Global System for Mobile Communications (GSM) system, a code-division multiple-access system (CDMA), a frequency modulated system, a Personal Communications Service (PCS) system, a cellular communications system, a messaging system, an analog cellular system that supports a Cellular Digital Packet Data (CDPD), or any communications system that supports short messaging service message (SMS) or text or alphanumeric messages, or a packet data network, for example.

The data processing system comprising a data collecter 216, a data processing unit 217, and an estimator and report generator software 218 applies the collected environmental and user input data to an agronomic model for managing an agricultural input (e.g., water or irrigation management) to determine an agricultural management parameter (e.g., an evapotranspiration estimate or indicator). For example, the data processing system applies the collected environmental data to an estimator 218 for estimating an evapotranspiration for a particular crop growing at a corresponding location. Although other techniques may be available, the agronomic model for water consumption can comprise estimating evapotranspiration in accordance with the Penman-Monteith method. The evapotranspiration, the crop identifier, and the crop stage of growth (or date) are applied to provide a prescription for water input on a geo-referenced basis.

In one example, additional processing can apply to the collected data or the agronomic model based on: (a) feedback from previous applications of prior collected environmental and user input data to the agronomic model, (b) machine learning techniques for successive applications of the agronomic model or (c) a priori calibration or adjustment of collected data to correct for measurement errors, system errors, model estimation errors, or otherwise. In this embodiment, the data processing system makes available a report for application of an agricultural input (e.g., quantity of water, volume of water, rate, frequency of application, recommended time window of application for water) to a crop in a particular location consistent with the collected data and the agronomic model. For example, the data processing system transmits a prescription (e.g., for irrigation or water allocations) via a user terminal 219 for a particular crop in a corresponding field which can then be sent to a grower terminal (not shown) via a communications network (e.g., Internet).

In the same manner, user collected data can be transmitted from a pretreatment plant to the system manager. In one embodiment, wherein one or more pretreatment plants is located onsite where the biomass resource is produced or collected, the data can be transmitted directly to the manager of the REIT or other association handling the processing of the data. If the pretreatment plant is owned by another entity, it is likely that it will go into a data collection and data processing system similar to the one used to collect data from the biomass resource site. Then the data or a report generated using the data is transmitted to the manager of the REIT or other association.

Pretreatment can vary from one feedstock to another. As an example, a lignocellulosic feedstock generally requires higher temperature, pressure and chemical, and then enzymatic treatment to release cellulose from lignin. The lignin solids have to be separated from the cellulose and hemicellulose, and byproducts can be formed or residual chemicals can remain that require removal from the sugar before it is further processes into monomers and/or biochemicals. This requires more time and energy than treatment of an algal biomass which contains no lignin, but comprises different carbohydrate polymers, or of municipal waste that may comprise mostly cellulose and other compounds. Further, a feedstock that comprises softwood can contain resins and terpenes that interfere with the pretreatment equipment and contaminate sugar solutions.

During the pretreatment process, monitoring sensors can track physical and chemical parameters and relay this data to a data processor through an interface similar to the one shown in FIG. 3. That is, temperature, pressure, pH, and time can be measured and stored so that optimal processing parameters for a particular feedstock can be determined. During pretreatment, operators can take further measurements regarding the condition of the feedstock as it moves through the system and is processed into components. Particle size, for example can be measured as the biomass is physically reduced in size for chemical treatments. This data can be entered electronically and stored in a data processor. The chemical sampling at various intervals can be recorded and provide information regarding the formation of saccharide monomers, inhibitors, and chemicals remaining in solution. Finally, impurities are removed by refining processes and final yields of sugars tallied. All of this information stored in a data processor can be compiled and cost of producing quality sugars of the type and purity required by different biochemical producers can be calculated. Depending on the end product, a manufacturer of a bioproduct may be seeking a cheap source of sugars and not require much refinement. Cruder sugar streams, e.g., for production of biofuels such as ethanol or butanol may only require limited purity from corn or sorghum feedstock. Sugar streams derived from softwoods however, may require costly purification to remove resins and terpenes prior to biofuel fermentation. A higher price can be asked for highly purified sugar streams necessary for bioplastic manufacture, and a softwood feedstock might still allow the pretreatment plant a higher profit even though the purification is more complex and costly. Thus, the manager of a pretreatment plant would seek out the proper feedstock for contract pricing with a biochemical plant. Consumers of saccharide streams produced from biomass have a variety of needs regarding the purity and concentration of the saccharides. In general, the more reduced the inhibitor concentration, the more fermentable the saccharides. Purified saccharides can be used to produce concentrated, clean end-products of fermentation such as succinic acid which is used as a precursor for plastic manufacture. To satisfy a wide range of consumers of saccharides, the amount of C5 and C6 saccharides that go into each batch for distribution must be controlled.

Knowing the pretreatment parameters of different feedstocks lets a manager predict the cost of extracting sugars from those feedstocks. Coupled with the cost of sugar transport (if the biochemical plant is located elsewhere), the pretreatment plant can determine the need for a quantity and type of biomass resource. The plant can transmit this data to the system manager linking realtime supply requirements to production planning analysis and contract pricing, such that those pretreatment plant entities with which the REIT or association is considering executing a business transaction can determine product pricing such that their biomass products are positioned favorably during the analysis process.

In FIG. 4, the examples of feedstock resources are timberland 3 (this could also be any perennial) that can have a pretreatment plant 7 located onsite, an annual crop 4, 6, such as corn, sorghum, sugarcane, or the like, or the crop can be a semiperennial crop 5 such as switchgrass, miscanthus, poplar or the like. Not shown, but another embodiment of this invention, can be an aquatic farm for macroalgae, or other aquatic farm/harvesting operation, or a municipal waste facility, or a site of food waste collection/harvest. Any of these biomass resource locations can have one or more pretreatment plants located at the site, for example, pretreatment plants 8 are shown at crop growing and harvesting site 4. Alternatively, a more centralized pretreatment plant 9 can receive biomass harvested from any biomass resource site. The pretreatment plants located at biomass resource sites are likely to be portable, meaning that they can be unassembled, transported, and reassembled at any feedstock site where required.

During any of these farming/accumulation operations, data is collected automatically through one or more sensors and a location-determining receiver. The sensors can be stationary in one or more sites within the growing area, or they can be located on a vehicle that can be driven or towed to one or more sites in the growing area. Such data would include soil and air moisture measurements, nutrient measurements, temperature, soil pH, and the like. Data that could be input by hand or photographs through tablets or other electronic transmitting devices, includes insect, disease, or animal affects on crop plants as well as germination and growth measurements. (See FIG. 3) The collected environmental and crop data is transmitted to a data processing system (at system management 1) via satellite 2, internet (not shown), or other transmitting system to determine an agricultural management parameter for that crop. This information can be used to determine the quality and quantity of yield for that crop. It can also be used to store the input data to use in an agronomic model to predict the theoretical and actual yields for an identical species or similar crop to be grown in that location. The operating costs are also collected for the crop grown at that location and transmitted to the data processing system to determine, along with the collected crop and environmental input, the cost of producing a measured unit (e.g., dry ton) of the feedstock. Operating costs can include, but are not limited to, cost of seed, weed control, fertilizer, labor, capital equipment, management costs, energy costs, harvesting cost, storage costs, and the like.

In one embodiment, a centralized pretreatment plant 9 extracts sugars from a biomass resource such as semiperennial crop 5 or annual crop 6 and then transports sugars as concentrated solubilized saccharide stream or sugar solids to biochemical plants 10 or biochemical plant 15 at a very remote location. This is more economical because it is less expensive to transport sugars than bulky biomass. In another embodiment, a biomass resource, such as an annual crop 6 is harvested and transported to portable pretreatment plants 12 located at a biochemical plant 13. In all of these instances, it is expected that the system manager receives data and information feedback regarding the quality and yield of the sugars produced from the biomass resource so that new strategies can be assessed and plans for future feedstock supplies can be calculated. In one embodiment, pretreatment plants 11 located at biochemical plant 14 can transmit resource requirements to the system management and the data and information already accumulated can be used to assess whether the manager can fulfill those requirements.

If the ownership of the agricultural land also controls the pretreatment plant, data is shared between the two networks 121 (FIG. 2) and, in most instances, the same network is used to coordinate the input data of both entities. Such coordination between a resource manager and one or more pretreatment plants can provide further optimization by reducing time and effort. One of skill in the art can understand that a system that coordinates a number of biomass resources and a number of pretreatment plants can calculate the best needs of the pretreatment plants and ensure that resources are not wasted.

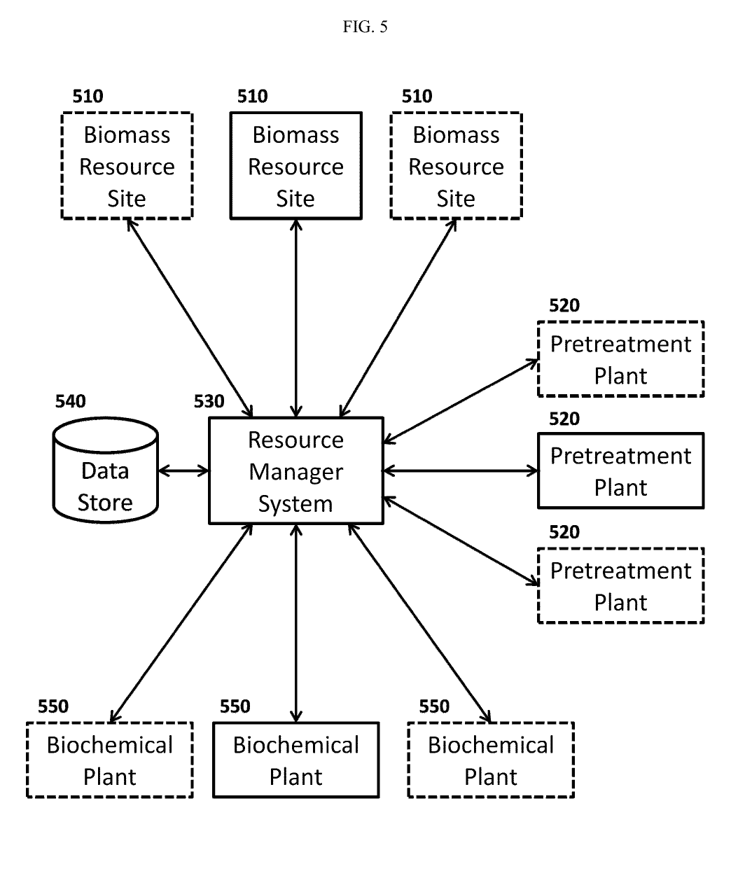

FIG. 5 illustrates an exemplary environment for implementing an embodiment of the invention. As illustrated, one or more biomass resource sites 510 connect via a network to a resource manager system 530 configured to provide optimized resource utilization functionalities as described herein. In various embodiments, the biomass resource sites 510 can comprise farmland, timberland, municipal waste sites, aquatic farms (e.g., oceanic farms), lumber mills, sources of food waste (e.g., restaurants, military bases, etc.) and the like. The biomass resource sites can be in common ownership or in an association or trust. The biomass resource sites can be independently operated.

In some embodiments, the biomass resource sites 510 comprise site data collecting and transmitting devices that are capable of communicating with the resource manager system 530. In some embodiments, the site data collecting and transmitting devices can collect data from one or more environmental monitoring devices and/or user input devices located at the biomass resource sites 510. The environmental monitoring devices can comprise a thermometer, a humidity sensor, a light sensor, a rain gauge, a wind sensor, a clock, a location determining receiver, or a combination thereof. The user input devices can be used for automatically or manually entering environmental data, crop data, harvest data, or a combination thereof. In some embodiments, the user input devices comprise personal computers, workstations, laptops, smartphones, mobile phones, tablet computing devices, smart TVs, game consoles, internet-connected setup boxes, and the like. The user input devices may include software such as web browsers and/or other applications for inputting data. In one embodiment, the communication between a biomass resource site 510 and the resource manager system 530 can be as illustrated in FIG. 4.

As illustrated, one or more pretreatment plants 520 can also connect via a network to the resource manager system 530. None, some, or all of the one or more pretreatment plants 520 can be located near or at a biomass resource site. None, some, or all of the one or more pretreatment plants 520 can be centrally located or located away from the biomass resource sites. In some embodiments, none, some, or all of the pretreatment plants are portable.

In some embodiments, the pretreatment plants can comprise plant data collecting and transmitting devices. The plant data collecting and transmitting devices can comprise a data processor (e.g., to collect and format data), a communications interface, a wireless transceiver or a combination thereof. In some embodiments, the plant data collecting and transmitting devices collects data from one or more equipment monitoring devices, one or more user input devices, or a combination thereof. The one or more equipment monitoring devices can comprise a thermometer, a pressure gauge, a pH meter, a clock, or a combination thereof. The one or more user input devices can be used to automatically or manually enter information such as pretreatment protocols, particle size data, saccharide yields, inhibitor or chemical levels, biomass resource needs (e.g., type or amount of a biomass resource needed), or a combination thereof. In some embodiments, the user input devices comprise personal computers, workstations, laptops, smartphones, mobile phones, tablet computing devices, smart TVs, game consoles, internet-connected setup boxes, and the like. The user input devices may include software such as web browsers and/or other applications for inputting data.

Some embodiments comprise or further comprise one or more biochemical plants 550 that can also connect via a network to the resource manager system 530.

In some embodiments, the biochemical plants 550 can comprise biochemical plant data collecting and transmitting devices. The biochemical plant data collecting and transmitting devices can comprise a data processor (e.g., to collect and format data), a communications interface, a wireless transceiver or a combination thereof. In some embodiments, the biochemical plant data collecting and transmitting devices collects data from one or more equipment monitoring devices, one or more user input devices, or a combination thereof. The one or more equipment monitoring devices can comprise a thermometer, a pressure gauge, a pH meter, a clock, or a combination thereof. The one or more user input devices can be used to automatically or manually enter information such as biochemical processing protocols, sugar resource needs (e.g., type, purity, or amount of a sugar resource needed), sugar consumption during processing, bioproduct yield, or a combination thereof. In some embodiments, the user input devices comprise personal computers, workstations, laptops, smartphones, mobile phones, tablet computing devices, smart TVs, game consoles, internet-connected setup boxes, and the like. The user input devices may include software such as web browsers and/or other applications for inputting data.

In some embodiments, the resource manager system 530 may be implemented by one or more physical and/or logical computing devices or computer systems that collectively provide the functionalities described herein. For example, aspects of the resource manager system 530 may be implemented by a single server or by a plurality of servers (e.g., distributed Hadoop nodes). As another example, aspects of the resource manager system 530 may be implemented by one or more processes running on one or more devices. In some embodiments, the resource manager system 530 may provide an API such as a web service interface that may be used by users or other processes or services to utilize the functionalities of the resource manager system 530 discussed herein.

In some embodiments, the resource manager system 530 may communicate with a data store 540 in order to perform the functionalities described herein. For example, the data store 540 may be used to store historical data, evaluation rules, and the like. Although the data store 540 is illustrated as communicating with the resource manager system 530, it is contemplated that the biomass resource sites, the pretreatment plants, the biochemical plants, or any other data source can communicate with the data store 540 directly or indirectly.

In some embodiments, the data store 540, or any other data stores discussed herein, may include one or more data files, databases (e.g., SQL database), data storage devices (e.g., tape, hard disk, solid-state drive), data storage servers, or the like. In various embodiments, such a data store 540 may be connected to the resource manager system 530 locally or remotely via a network. In some embodiments, data store 540, or any other data stores discussed herein, may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

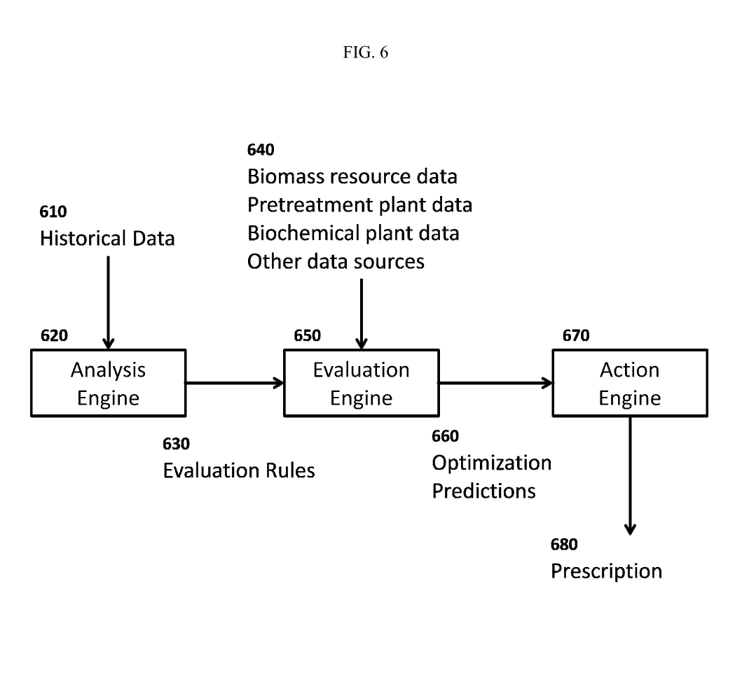

FIG. 6 illustrates example components of a resource manager system, in accordance with an embodiment. The resource manager system may be similar to the resource manager system 530 discussed in FIG. 5. In various embodiments, the resource manager system may include one or more components that individually or collectively provide a set of functionalities. Each component may be implemented by one or more physical and/or logical computing devices, such as computers, data storage devices and the like. Some or all of the components may be co-located on the same device or distributed on different devices. The components may communicate with each other or with external entities such as other systems, devices or users. It will be appreciated by those of ordinary skill in the art that various embodiments may have fewer or a greater number of components or subcomponents than those illustrated in FIG. 6. Thus, the depiction of the environment in FIG. 6 or in other figures should be taken as being illustrative in nature and not limiting to the scope of the disclosure.

In the illustrated embodiment, the resource manager system includes an analysis engine 620, an evaluation engine 650, and an action engine 670. In some other embodiments, the resource manager system may include a subset or a superset of the illustrated components. For example, in an embodiment, the resource manager system may include only the evaluation engine. In another embodiment, the resource manager system may include only the analysis engine and the evaluation engine. In some embodiments, some or all of the components discussed herein may be combined or further divided into subcomponents.

The analysis engine 620 may be configured to generate, based on historical data 610, evaluation rules or rules 630 that may be used to optimize resource usage. The rules may be used, for example, by the evaluation engine 650, to produce optimization predictions based upon provided data (e.g., biomass resource data, pretreatment plant data, biochemical plant data, or other data sources) 640. Such rules may be derived based on historical data obtained from many previous production processes or resource transactions. For example, the rules may include one or more parameter maps that map parameter values (original or derived) to weight values. The rules may further include formulas, algorithms, and the like for using the maps (e.g., combining the weight values) to derive a resource optimization prediction. Various techniques may be used to derive the rules including machine learning and/or data mining techniques such as neural networks, fuzzy logic, statistical analysis (e.g., logistical regression), and the like. In a typical embodiment, the size of the rules is a fraction of the amount of the historical data based on which the rules are derived. Rules may be generated automatically with aid of a processor. Human intervention may or may not be required for generating the rules.

Optimizing resource utilization can comprise optimizing the production of biomass resource at biomass resource sites, optimizing the production of sugars at pretreatment plants, optimizing the production of bioproducts at a bioproduct plant, or a combination thereof. The nature of the historical data can depend upon the process being optimized. Historical data can include data from previous process runs (e.g., crop growth, sugar extraction, biochemical production, etc.). Historical data can include publically available data such as crop reports, media reports, weather report or almanacs, and the like.

Historical data for the optimization of biomass resource production can include, but is not limited to, environmental data, crop data, harvest data, economic data, or a combination thereof. Environmental data can include, but is not limited to, temperature data, humidity data, light data, rain data, wind data, time, soil nutrient data, location data, or a combination thereof. Crop data can include, but is not limited to, growth data, insect data, parasite data, disease data, crop damage data, or a combination thereof. Harvest data can include, but is not limited to, what crop was harvested, how much crop was harvested, the moisture content of the harvested material, the saccharide content (e.g., ratio of starch, lignin, cellulose, and hemicellulose) of the harvested material, or a combination thereof. Economic data can include, but is not limited to, labor requirements, equipment requirements, material requirements, or a combination thereof. A plurality of rules can be combined in a predictive model, such as an agronomic model, a pretreatment model, or a bioprocess model.

Historical data for the optimization of sugar extraction from biomass can include, but is not limited to, the biomass resource used, the pretreatment parameters used, the saccharide yields attained, the saccharide purity levels attained, or a combination thereof. Biomass resource data can include the type of crop, the amount of material, the conditions of material (e.g., water levels, saccharide content, etc.), or a combination thereof. Pretreatment parameters can include pretreatment protocols (e.g., the mechanical, chemical, or enzymatic processes used); process temperatures, pressures, pHs, times, particle sizes; or a combination thereof. Saccharide purity level data can include saccharide concentrations, inhibitor or chemical concentrations, or a combination thereof.

Historical data for the optimization of biochemical production from sugars can include, but is not limited to, production protocols, sugar consumption, biochemical yields, and the like.

The historical data may include data (including statistics) related to past production processes (e.g., biomass resource production, sugar production, bioproduct production), past resource transactions, media reports, agricultural reports, and the like. For example, historical data can indicate that certain regions are more suitable to some types of crops and not others. Historical data can indicate that certain soil conditions favor the growth of one type of crop over another. Historical data can indicate that it is cheaper to produce sugars from certain biomass resources than others. Historical data can indicate that some bioproducts can be produced from cruder sugar streams while others may require a higher level of purity or more specific ratios of C5 to C6 sugars.

The evaluation engine 650 can be configured to determine one or more optimization predictions based upon the evaluation rules and the data provided (e.g., biomass resource data, pretreatment plant data, biochemical plant data, or other data).

In some embodiments, the biomass resource data 640 comprises environmental data, crop data, harvest data, or a combination thereof. In some embodiments, the biomass resource data comprises the environmental data that comprises temperature data, humidity data, light data, rain data, wind data, time, soil nutrient data, location data, or a combination thereof. In some embodiments, the biomass resource data comprises the crop data that comprises growth data, insect data, parasite data, disease data, crop damage data, or a combination thereof. In some embodiments, the biomass resource data comprises the harvest data that comprises what was harvested, how much was harvested, the moisture content of the harvested material, the saccharide content (e.g., ratio of starch, lignin, cellulose, and hemicellulose) of the harvested material, or a combination thereof. These same types of data can be historical data 610, provided from previous biomass resource production processes.

In some embodiments, the pretreatment plant data 640 comprises biomass resource needs, pretreatment parameters, saccharide yields, saccharide purity levels, economic data, or a combination thereof. In some embodiments, the pretreatment plant data comprises the biomass resource needs that comprise a type of biomass resource, an amount of biomass resource, or a combination thereof. In some embodiments, the pretreatment plant data comprises the pretreatment parameters that comprise a pretreatment protocol; a process temperature, pressure, pH, time, particle size; or a combination thereof. In some embodiments, the pretreatment plant data comprises the saccharide purity levels that comprise saccharide concentration, inhibitor or chemical concentration, or a combination thereof. Economic data can include, but is not limited to, labor requirements, equipment requirements, material requirements, or a combination thereof. These same types of data can be historical data. 610, provided from previous sugar production processes.

In some embodiments, the biochemical plant data 640 comprises biochemical processing protocols, biochemical process parameters, sugar resource needs, sugar consumption during processing, bioproduct yield, or a combination thereof. In some embodiments, the biochemical plant data comprises the biochemical process parameters that comprise temperature, pressure, pH, time, or a combination thereof. In some embodiments, the biochemical plant data comprises the sugar resource needs that comprise a type of sugar, an amount of sugar resource, a purity level, or a combination thereof. In some embodiments, the biochemical plant data comprises the biochemical processing parameters that comprise a temperature, pressure, pH, time, or a combination thereof. These same types of data can be historical data. 610, provide from previous sugar production processes.

Based at least in part on data provided (e.g., biomass resource data, pretreatment plant data, biochemical plant data, or other data), the evaluation engine 650 can be configured to select and apply some or all of the evaluation rules 630 made available by the analysis engine 620. In some embodiments, the evaluation rules may be stored in a data store or data file that is made available to the evaluation engine 650. The evaluation rules may be applied to at least some of the data provided to derive optimization predictions.

Optimization predictions can include economic predictions, such as the a cost for a measured unit of the biomass resource, the cost of producing sugars from the biomass resource, the cost of growing a crop at a particular biomass resource site, the cost of producing a particular bioproduct from a sugar stream, and the like. Optimization predictions can include production predictions such as the expected yield of a particular crop at a particular site, the optimum conditions for growing a particular crop (e.g., the optimum soil nutrient level), the optimum conditions for extracting sugars from a particular biomass, the optimum conditions for producing a bioproduct from a particular sugar resource, and the like.

The optimization predictions can be used by the action engine to generate a report or a prescription containing, for example, prices for required resources, recommended production processes or changes to an ongoing production process, and the like. The report or prescription can be transmitted, for example, to a biomass resource site, a pretreatment plant, a biochemical plant.

In some embodiments, the resource manager system transmits a biomass resource site prescription to at least one biomass resource site. In some embodiments, a biomass resource site prescription comprises labor requirements, equipment requirements, material requirements, or a combination thereof. In some embodiments, the biomass resource site prescription comprises instructions for planting, watering, fertilizing, pesticide treating, harvesting, post-harvest processing, shipping, or a combination thereof. In some embodiments, the biomass resource site prescription comprises instructions for planting that comprise when to plant, where to plant, what to plant, an amount to plant, or a combination thereof. In some embodiments, the biomass resource site prescription comprises instructions for watering that comprise when to water, where to water, how much to water, or a combination thereof. In some embodiments, the biomass resource site prescription comprises instructions for fertilizing that comprise when to fertilize, where to fertilize, what fertilizer to use, how much fertilizer to use, or a combination thereof. In some embodiments, the biomass resource site prescription comprises instructions for pesticide treating that comprise when to treat, where to treat, what pesticide to use, how much pesticide to use, or a combination thereof. In some embodiments, the biomass resource site prescription comprises instructions for harvesting that comprise when to harvest, where to harvest, what to harvest, how much to harvest, or a combination thereof. In some embodiments, the biomass resource site prescription comprises instructions for post-harvest processing that comprise hydrating the harvested biomass, drying the harvested biomass, storing the harvested biomass, or a combination thereof. In some embodiments, the biomass resource site prescription comprises instructions for shipping that comprise what to ship, where to ship, an amount to ship, or a combination thereof.

In some embodiments, the resource manager system transmits a pretreatment plant prescription to at least one pretreatment plant. In some embodiments, the pretreatment plant prescription comprises instructions for extraction of sugars from the biomass resource, refinement of sugars, or a combination thereof.

In some embodiments, the resource manager system transmits a biochemical plant prescription to at least one biochemical plant. In some embodiments, the pretreatment plant prescription comprises a price for a sugar resource, instructions for the production of a biochemical from the sugar resource, or a combination thereof.

In some embodiments, analysis engine 620, the evaluation engine 650, and the action engine 670, may reside on the same or different computing devices and may each be implemented by one or more computing devices or processes. In some embodiments, the rules, the optimization predictions, and/or the prescriptions may be generated in real or nearly real time as the provided data is coming in, or in an asynchronous fashion such as in using batch processing. In some embodiments, the generation of rules and the evaluation of the provided data can be independent from each other. The rules may be generated and/or updated at a different time schedule than that for the evaluation of the provided data. For example, in an embodiment, the rules are generated ahead of time and updated on a periodic basis. Independently or asynchronously to the generation and/or update of rules, the provided data may be evaluated in real or nearly real time using the rules.

In some embodiments, analysis engine, the evaluation engine and the action engine may be configured to provide the various functionalities discussed herein in a synchronous or asynchronous fashion. For example, the generation of rules may be performed offline, in an asynchronous fashion. The evaluation of the provided data to produce the optimization predictions may be performed in real time or nearly real time as the provided data is received. The determining of a prescription based on the optimization predictions may be performed in real time or nearly real time.

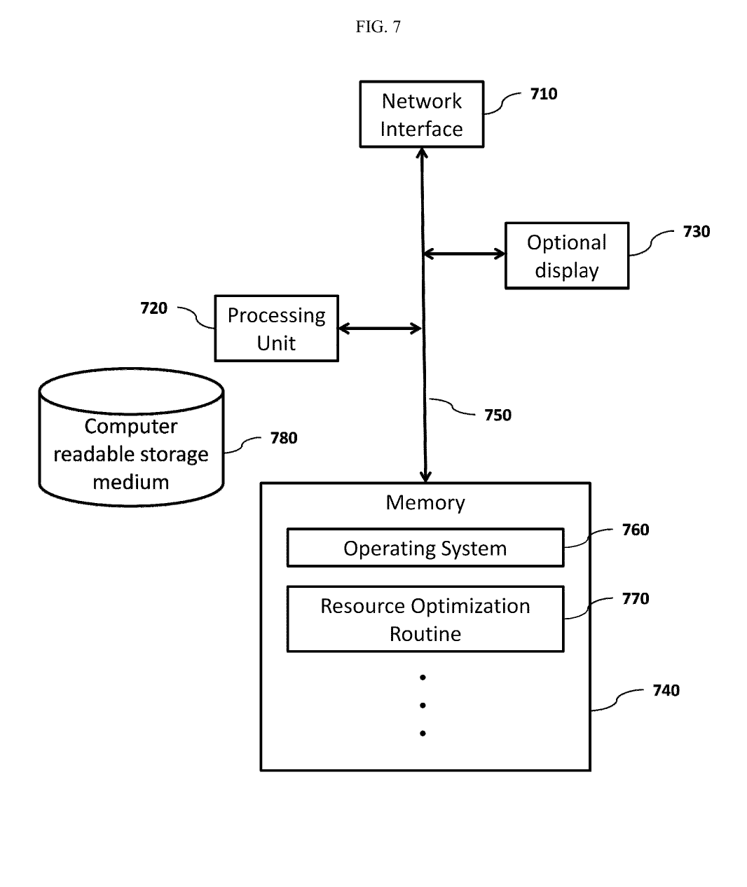

FIG. 7 illustrates example components of a computer device for implementing aspects of the present invention, in accordance with an embodiment. In one embodiment, the computer device may be configured to implement a data collecting and transmitting device, discussed in connection with FIG. 5 and/or components or aspects of the resource manager system such as described in connection with FIGS. 5 and 6. In some embodiments, computing device may include many more components than those shown in FIG. 7 However, it is not necessary that all of these components be shown in order to disclose an illustrative embodiment.

As shown in FIG. 7, computing device includes a network interface 710 for connecting to a network such as discussed above. In various embodiments, the computing device may include one or more network interfaces 710 for communicating with one or more types of networks such as the Internet, wireless networks, cellular networks, and any other network.

In an embodiment, computing device also includes one or more processing units 720, a memory 740, and an optional display 730, all interconnected along with the network interface 710 via a bus 750. The processing unit(s) 720 may be capable of executing one or more methods or routines stored in the memory 740. The display 730 may be configured to provide a graphical user interface to a user operating the computing device for receiving user input, displaying output, and/or executing applications. In some cases, such as when the computing device is a server, the display 730 may be optional.

The memory 740 may generally comprise a random access memory (“RAM”), a read only memory (“ROM”), and/or a permanent mass storage device, such as a disk drive. The memory 740 may store program code for an operating system 760, one or more resource optimization routines 770, and other routines. In various embodiments, the program code may be stored on a computer-readable storage medium, for example, in the form of a computer program comprising a plurality of instructions executable by one or more processors. The computer-readable storage medium may be non-transitory. The one or more resource optimization routines 770, when executed, may provide various functionalities associated with the resource management system as described herein.

In some embodiments, the software components discussed above may be loaded into memory 740 using a drive mechanism associated with a non-transient computer readable storage medium 780, such as a floppy disc, tape, DVD/CD-ROM drive, memory card, USB flash drive, solid state drive (SSD) or the like. In other embodiments, the software components may alternatively be loaded via the network interface 710, rather than via a non-transient computer readable storage medium 780. In an embodiment, the computing device also include an optional time keeping device (not shown) for keeping track of the timing of transactions or network events.

In some embodiments, the computing device also communicates via bus 750 with one or more local or remote databases or data stores such as an online data storage system via the bus 750 or the network interface 710. The bus 750 may comprise a storage area network (“SAN”), a high-speed serial bus, and/or via other suitable communication technology. In some embodiments, such databases or data stores may be integrated as part of the computing device.

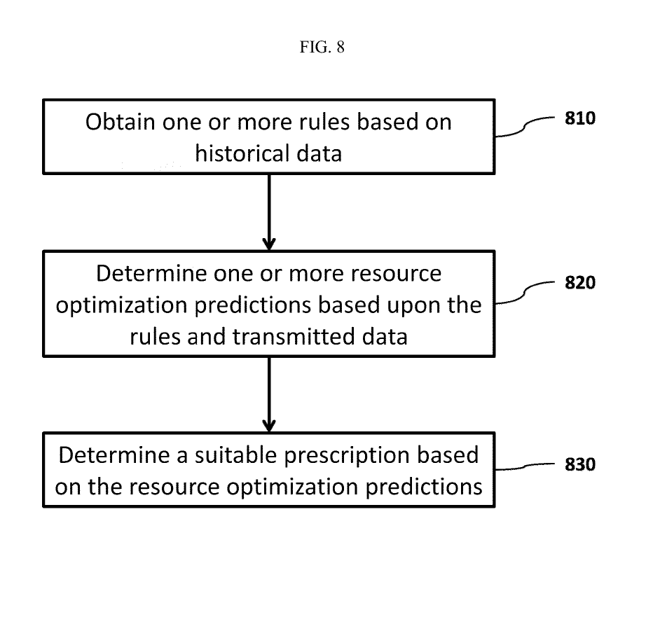

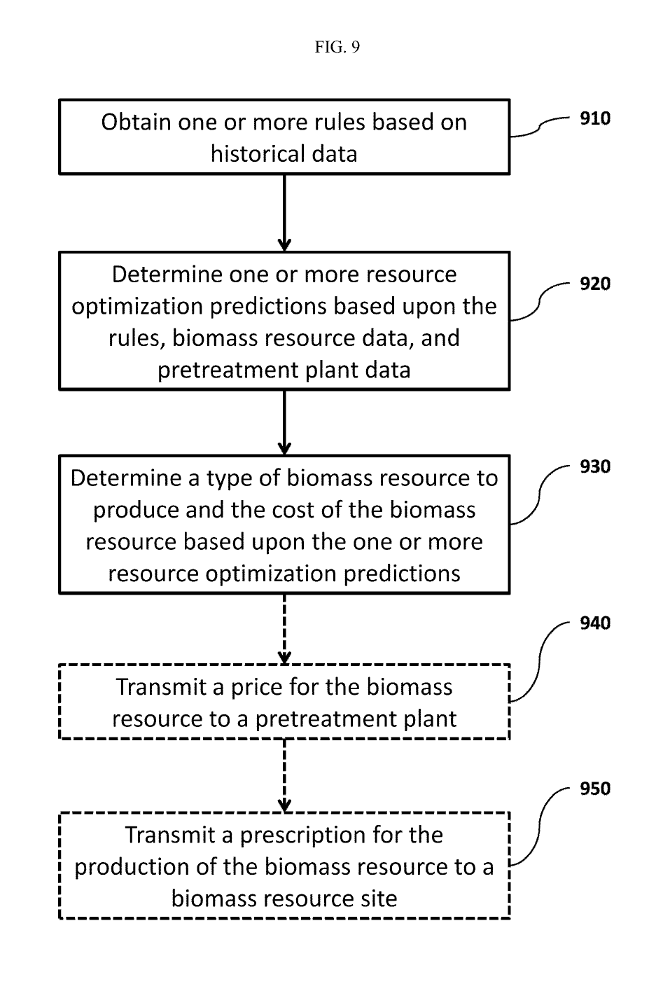

FIGS. 8 and 9 illustrates example processes for implementing the present invention, in accordance with an embodiment. Aspects of these processes may be performed, for example, by a resource manager system such as discussed in connection with FIGS. 5 and 6 or one or more computing devices such as discussed in connection with FIG. 7. Some or all aspects of the processes (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

In an embodiment illustrated in FIG. 8, the process includes obtaining 810 one or more rules (e.g., a set of rules) based on historical data; determining 820 one or more resource optimization predictions based upon the rules and transmitted data (e.g., bioresource data, pretreatment data, biochemical data, etc.) and determining 830 a suitable prescription based on the resource optimization prescriptions.

In a specific embodiment illustrated in FIG. 9, the process includes obtaining 910 one or more rules based on historical data; determining 920 one or more resource optimization predictors based upon the rules, biomass resource data, and pretreatment plant data; and determining 930 a type of biomass resource to produce and the cost of the biomass resource based upon the one or more resource optimization predictions. The process can optionally include transmitting 940 a price for the biomass resource to a pretreatment plant. The process can optionally include transmitting 950 a prescription for the production of the biomass resource to a biomass resource site.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A system for determining biomass resource utilization in the production of sugars, the system comprising:
(a) one or more biomass resource sites;
(b) a site data collecting and transmitting device at each of the one or more biomass resource sites to transmit biomass resource data to a resource manager system;
(c) one or more pretreatment plants;
(d) a plant data collecting and transmitting device at each of the one or more pretreatment plants to transmit pretreatment plant data to the resource manager system;
(e) the resource manager system for determining biomass resource utilization comprising:
(i) one or more processors, and
(ii) memory, including instructions executable by the one or more processors to cause the resource manager system to at least:
(1) obtain one or more evaluation rules based at least in part on historical data,
(2) determine one or more resource optimization predictions based at least in part upon the one or more evaluation rules, the biomass resource data, and the pretreatment plant data, and
(3) determine a type of biomass resource to produce and a cost of producing the biomass resource based at least in part upon the one or more resource optimization predictions.

2. The system of claim 1, wherein the resource manager system further comprises instructions that transmits a price for the biomass resource to a consumer.

3. The system of claim 1, wherein the one or more resource optimization predictions comprise a cost for a measured unit of the biomass resource, the cost of producing sugars from the biomass resource, or a combination thereof.

4. (canceled)

5. The system of claim 1, wherein obtaining the one or more evaluation rules includes analyzing the historical data using a machine learning technique.

6. (canceled)

7. (canceled)

8. (canceled)

9. (canceled)

10. (canceled)

11. The system of claim 1, wherein at least one pretreatment plant is portable.

12. (canceled)

13. The system of claim 1, wherein the site data collecting and transmitting device collects data from one or more environmental monitoring devices, one or more user input devices, or a combination thereof.

14. The system of claim 13, comprising the one or more environmental monitoring devices that comprise a thermometer, a humidity sensor, a light sensor, a rain gauge, a wind sensor, a clock, a location determining receiver, or a combination thereof.

15. (canceled)

16. The system of claim 1, wherein the biomass resource data comprises environmental data, crop data, harvest data, or a combination thereof.

17. The system of claim 16, wherein the biomass resource data comprises the environmental data that comprises temperature data, humidity data, light data, rain data, wind data, time, soil nutrient data, location data, or a combination thereof.

18. The system of claim 16, wherein the biomass resource data comprises the crop data that comprises growth data, insect data, parasite data, disease data, crop damage data, or a combination thereof.

19. The system of claim 16, wherein the biomass resource data comprises the harvest data that comprises what was harvested, how much was harvested, a moisture content of harvested material, a saccharide content of harvested material, or a combination thereof.

20. (canceled)

21. (canceled)

22. (canceled)

23. The system of claim 1, wherein the pretreatment plant data comprises biomass resource needs, pretreatment parameters, saccharide yields, saccharide purity levels, or a combination thereof.

24. The system of claim 23, wherein the pretreatment plant data comprises the biomass resource needs that comprise a type of biomass resource, an amount of biomass resource, or a combination thereof.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A method for determining biomass resource utilization, the method comprising:
(a) obtaining biomass resource data from one or more biomass resource sites;
(b) obtaining pretreatment plant data from one or more pretreatment plants;
(c) obtaining one or more evaluation rules based at least in part on historical data;
(d) determining one or more resource optimization predictions based at least in part upon the one or more evaluation rules, the biomass resource data, and the pretreatment plant data, and
(e) determining a type of biomass resource to produce and a cost of producing the biomass resource based at least in part upon the one or more resource optimization predictions; and
(f) transmitting a price for the biomass resource to a consumer.

52. The method of claim 51, further comprising measuring at least some of the biomass resource data.

53. (canceled)

54. The method of claim 51, wherein the one or more resource optimization predictions comprise a cost for a measured unit of the biomass resource, the cost of producing sugars from the biomass resource, or a combination thereof.

55. (canceled)

56. The method of claim 51, wherein obtaining the one or more evaluation rules includes analyzing the historical data using a machine learning technique.

57. (canceled)

58. (canceled)

59. (canceled)

60. (canceled)

61. (canceled)

62. The method of claim 51, wherein at least one pretreatment plant is portable.

63. (canceled)

64. (canceled)

65. (canceled)

66. (canceled)

67. (canceled)

68. The method of claim 51, wherein the biomass resource data comprises environmental data, crop data, harvest data, or a combination thereof.

69. The method of claim 68, wherein the biomass resource data comprises the environmental data that comprises temperature data, humidity data, light data, rain data, wind data, time, soil nutrient data, location data, or a combination thereof.

70. The method of claim 68, wherein the biomass resource data comprises the crop data that comprises growth data, insect data, parasite data, disease data, crop damage data, or a combination thereof.

71. The method of claim 68, wherein the biomass resource data comprises the harvest data that comprises what was harvested, how much was harvested, a moisture content of harvested material, a saccharide content of harvested material, or a combination thereof.

72. (canceled)

73. (canceled)

74. (canceled)

75. (canceled)

76. The method of claim 51, wherein the pretreatment plant data comprises biomass resource needs, pretreatment parameters, saccharide yields, saccharide purity levels, or a combination thereof.

77. The method of claim 76, wherein the pretreatment plant data comprises the biomass resource needs that comprise a type of biomass resource, an amount of biomass resource, or a combination thereof.

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. A computer system for determining biomass resource utilization, comprising:
(a) one or more processors; and,
(b) memory, including instructions executable by the one or more processors to cause the computer system to at least:
(i) obtain biomass resource data from two one or more biomass resource sites,
(ii) obtain pretreatment plant data from one or more pretreatment plants,
(iii) obtain one or more evaluation rules based at least in part on historical data,
(iv) determine one or more resource optimization predictions based at least in part upon the one or more evaluation rules, the biomass resource data, and the pretreatment plant data,
(v) determine a type of biomass resource to produce and a cost of producing the biomass resource based at least in part upon the one or more resource optimization predictions, and
(vi) transmit a price for the biomass resource to a consumer.

108. The system of claim 107, wherein the one or more resource optimization predictions comprise a cost for a measured unit of the biomass resource, the cost of producing sugars from the biomass resource, or a combination thereof.

109. (canceled)

110. The system of claim 107, wherein the one or more evaluation rules are obtained by analyzing the historical data using a machine learning technique.

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. The system of claim 107, wherein the biomass resource data comprises environmental data, crop data, harvest data, or a combination thereof.

123. The system of claim 122, wherein the biomass resource data comprises the environmental data that comprises temperature data, humidity data, light data, rain data, wind data, time, soil nutrient data, location data, or a combination thereof.

124. The system of claim 122, wherein the biomass resource data comprises the crop data that comprises growth data, insect data, parasite data, disease data, crop damage data, or a combination thereof.

125. The system of claim 122, wherein the biomass resource data comprises the harvest data that comprises what was harvested, how much was harvested, a moisture content of harvested material, a saccharide content of harvested material, or a combination thereof.

126. (canceled)

127. (canceled)

128. (canceled)

129. (canceled)

130. The system of claim 107, wherein the pretreatment plant data comprises biomass resource needs, pretreatment parameters, saccharide yields, saccharide purity levels, or a combination thereof.

131. The system of claim 130, wherein the pretreatment plant data comprises the biomass resource needs that comprise a type of biomass resource, an amount of biomass resource, or a combination thereof.

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)

159. (canceled)

160. (canceled)

161. (canceled)

162. (canceled)

163. (canceled)

164. (canceled)

165. (canceled)

166. The method of claim 51, performed under the control of one or more computer systems configured with executable instructions.

167. A method of determining biomass resource utilization in the production of sugars, the method comprising:
(a) transmitting biomass resource data from a site data collecting and transmitting device located at each of one or more biomass resource sites to a resource manager system;
(b) transmitting pretreatment plant data from a plant data collecting and transmitting device located at each of one or more pretreatment plants to the resource manager system;
(c) obtaining one or more evaluation rules based at least in part on historical data;
(d) determining one or more resource optimization predictions based at least in part upon the one or more evaluation rules, the biomass resource data, and the pretreatment plant data; and
(e) determining a type of biomass resource to produce and a cost of producing the biomass resource based at least in part upon the one or more resource optimization predictions;
wherein the resource manager system comprises one or more processors, and memory, including instructions executable by the one or more processors to cause the resource manager system to at least do (c), (d), and (e).

168. The method of claim 167, wherein the resource manager system further comprises instructions that transmits a price for the biomass resource to a consumer.

169. The method of claim 167, wherein the one or more resource optimization predictions comprise a cost for a measured unit of the biomass resource, the cost of producing sugars from the biomass resource, or a combination thereof.

170. The method of claim 167, wherein obtaining the one or more evaluation rules includes analyzing the historical data using a machine learning technique.

171. The method of claim 167, wherein the biomass resource data comprises environmental data, crop data, harvest data, or a combination thereof.

172. The method of claim 171, wherein the biomass resource data comprises the environmental data that comprises temperature data, humidity data, light data, rain data, wind data, time, soil nutrient data, location data, or a combination thereof.

173. The method of claim 171, wherein the biomass resource data comprises the crop data that comprises growth data, insect data, parasite data, disease data, crop damage data, or a combination thereof.

174. The method of claim 171, wherein the biomass resource data comprises the harvest data that comprises what was harvested, how much was harvested, a moisture content of harvested material, a saccharide content of harvested material, or a combination thereof.

175. The method of claim 167, wherein the pretreatment plant data comprises biomass resource needs, pretreatment parameters, saccharide yields, saccharide purity levels, or a combination thereof.

176. The method of claim 175, wherein the pretreatment plant data comprises the biomass resource needs that comprise a type of biomass resource, an amount of biomass resource, or a combination thereof.

177. A computer readable storage medium suitable for use in an electronic device and having instructions recorded thereon for execution on the electronic device, the instructions comprising:
(a) obtaining biomass resource data from one or more biomass resource sites;
(b) obtaining pretreatment plant data from one or more pretreatment plants;
(c) obtaining one or more evaluation rules based at least in part on historical data;
(d) determining one or more resource optimization predictions based at least in part upon the one or more evaluation rules, the biomass resource data, and the pretreatment plant data,
(e) determining a type of biomass resource to produce and a cost of producing the biomass resource based at least in part upon the one or more resource optimization predictions; and
(f) transmitting a price for the biomass resource to a consumer.

178. The computer readable storage medium of claim 177, wherein the one or more resource optimization predictions comprise a cost for a measured unit of the biomass resource, the cost of producing sugars from the biomass resource, or a combination thereof.

179. The computer readable storage medium of claim 177, wherein obtaining the one or more evaluation rules includes analyzing the historical data using a machine learning technique.

180. The computer readable storage medium of claim 177, wherein the biomass resource data comprises environmental data, crop data, harvest data, or a combination thereof.

181. The computer readable storage medium of claim 180, wherein the biomass resource data comprises the environmental data that comprises temperature data, humidity data, light data, rain data, wind data, time, soil nutrient data, location data, or a combination thereof.

182. The computer readable storage medium of claim 180, wherein the biomass resource data comprises the crop data that comprises growth data, insect data, parasite data, disease data, crop damage data, or a combination thereof.

183. The computer readable storage medium of claim 180, wherein the biomass resource data comprises the harvest data that comprises what was harvested, how much was harvested, a moisture content of harvested material, a saccharide content of harvested material, or a combination thereof.

184. The computer readable storage medium of claim 177, wherein the pretreatment plant data comprises biomass resource needs, pretreatment parameters, saccharide yields, saccharide purity levels, or a combination thereof.

185. The computer readable storage medium of claim 184, wherein the pretreatment plant data comprises the biomass resource needs that comprise a type of biomass resource, an amount of biomass resource, or a combination thereof.
